(19) United States
(12) Patent Application Publication
(10) Pub. No.: US 2026/0267672 A1
(43) Pub. Date: Sep. 10, 2026

(54) COMPUTERIZED-SYSTEMS AND COMPUTERIZED-METHODS FOR LARGE LANGUAGE MODEL DRIVEN GUIDANCE OF DESIGN AND IMPLEMENTATION OF A USER INTERFACE

(71) Applicant: Actimize LTD., Ra'anana (IL)

(72) Inventors: Darshan AMBHAIKAR, Pune (IN); Ashadeepa DEBNATH, Pune (IN); Aaron MIRSKY, Petch Tikva (IL)

(21) Appl. No.: 19/071,812

(22) Filed: Mar. 6, 2025

(51) Int. Cl. G06F 9/451; G06F 8/20; G06F 40/289

(52) U.S. Cl. CPC G06F 9/453; G06F 8/20; G06F 40/289

(57) ABSTRACT

A computerized-method for large language model driven guidance of design and implementation of elements in a UI. The computerized-method includes: (i) receiving a query related to a UI page of an application. The query is related to an operation of the application, by one or more elements of the UI; (ii) processing the received query, by the one or more processors, to yield position of each element in the one or more UI elements related to the query on the UI page and a guidance in text-format of the one or more UI elements; and (iii) displaying the guidance as lingual-instructions of the operation of the application in text-format on the UI page and signaling the one or more UI elements related to the query with a visual cue on the UI page based on the position of each UI element in the one or more UI elements.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of computerized systems and methods for large language model driven guidance of design and implementation of elements in a user interface.

### BACKGROUND

In complex software environments, such as enterprise systems, financial platforms, customer support tools, and data management systems, users often face challenges in navigating complex software interfaces and accessing the right information at the right time. Traditional documentation and support systems often fail to provide the immediate, context-aware assistance necessary to resolve issues efficiently. This leads to increased time spent on investigations or customer queries, potential errors, and reduced overall satisfaction. Moreover, capturing detailed user interaction data to identify specific pain points within the software remains difficult, hindering continuous improvement efforts.

Due to complex software interfaces, users face difficulties navigating intricate systems, particularly in financial crime management and customer support environments and similar solutions. Moreover, inefficient documentation by traditional support methods lacks the contextual guidance needed for users to quickly find and apply the correct information.

There may be prolonged task completion, as without real-time, UI-integrated assistance, users spend more time resolving issues, leading to delays, errors, and reduced satisfaction. Also, organizations struggle to capture precise data on where users encounter problems, hindering continuous improvement efforts.

The combined effect is a reduction in operational efficiency, increased frustration for users, and missed opportunities for refining software interfaces based on actual user experiences. Instructions often lack direct links to the User Interface (UI), causing confusion and inefficiency. Users struggle with mentally mapping instructions to UI elements, leading to frustration.

Traditional analytics miss key user struggles, hindering targeted improvements. Also, non-adaptive documentation fails to provide timely, relevant assistance, impacting user experience.

Accordingly, there is a need for a technical solution for an integrated, context-aware system that will improve user assistance and experience.

### SUMMARY

There is thus provided, in accordance with some embodiments of the present disclosure, a computerized-method for large language model driven guidance of design and implementation of elements in a user interface.

In accordance with some embodiments of the present disclosure, the computerized-method may include: (i) receiving, by one or more processors, from a user, a query related to a User Interface (UI) page of an application, that is running on a computerized-device and presented on a display unit associated to the computerized-device. The query is related to an operation of the application, by one or more elements of the UI; (ii) processing the received query, by the one or more processors, to yield position of each element in the one or more UI elements related to the query on the UI page and a guidance in text-format of the one or more UI elements; and (iii) displaying the guidance as lingual-instructions of the operation of the application in text-format on the UI page and signaling the one or more UI elements related to the query with a visual cue on the UI page based on the position of each UI element in the one or more UI elements.

Furthermore, in accordance with some embodiments of the present disclosure, the processing of the query may include: (i) evaluating context of the query by transferring the query, by the one or more processors to an assessment module and operating the assessment module, by the one or more processors; (ii) retrieving contextual guidance and a position of each UI element in the one or more UI elements by operating a context retrieval module based on the evaluated context of the query; (iii) using the retrieved contextual guidance to search in one or more sources of information and retrieve guidance-information; (iv) determining UI context based on an analysis of the guidance-information. The UI context comprising currently viewed UI page, actions operated via the UI page, related user-input, active UI elements and details of the user; (v) identifying one or more UI elements related to the query based on the UI context and generating a token for each UI element in the one or more UI elements, with metrics of the UI element. The metrics may include an assigned name of the UI element and the position of the UI element on the UI page and embedding the assigned name of each UI element in the guidance in text-format.

Furthermore, in accordance with some embodiments of the present disclosure, the query may be received by one of: keyboard input and voice input. When the query is received by the voice input, the computerized-method may further include converting the voice input into text by using a speech-to-text tool.

Furthermore, in accordance with some embodiments of the present disclosure, the computerized-method may further include playing voice-instructions of the operation in the application in audio-format. The voice-instructions are corresponding to the lingual-instructions of the operation in the application in text-format.

Furthermore, in accordance with some embodiments of the present disclosure, the computerized-method may further include: (i) monitoring, by the one or more processors, to calculate number of queries related to each operation of each UI element in each UI page of the application during a preconfigured time; (ii) generating a report with a preconfigured number of UI elements having highest number of queries; and (iii) displaying the report via a display unit.

Furthermore, in accordance with some embodiments of the present disclosure, the assessment module may include: (i) receiving the query; (ii) preparing the query for an evaluation; (iii) determining a type of guidance by analyzing the prepared query; (iv) identifying keywords, phrases and complexity of the query, by operating pretrained machine learning models. The complexity of the query comprising one or more factors; (v) determining a source of response to the query and priority level based on the identified keywords, phrases and complexity of the query; and (vi) sending the source of response, the type of guidance, and the priority level as the evaluated context of the query to the context retrieval module.

Furthermore, in accordance with some embodiments of the present disclosure, the LLM may be further trained by: (i) mapping predefined IDs of elements of the UI to text labels by using a UI tool; (ii) analyzing a hierarchy of the elements of the UI and respective position in the UI page, leveraging the predefined ID for each element in the elements of the UI, by using the UI tool; (iii) providing a mapping document that links keywords and phrases to elements of the UI page; and (iv) providing a product documentation of the application to be ingested by the LLM based on descriptive information of the elements of each UI page.

Furthermore, in accordance with some embodiments of the present disclosure, the type of guidance may be one of: (i) technical issue; (ii) user manual request; (iii) troubleshooting assistance; (iv) configuration support; (v) error message clarification; (vi) warning message clarifications; and (vii) feature explanation.

Furthermore, in accordance with some embodiments of the present disclosure, the context retrieval module may include: (i) receiving the evaluated context of the query; (ii) identifying a position of the UI element to be added to a contextual-data database; (iii) analyzing recorded actions of the user during a preconfigured period of time to yield data related to the UI page to be added to the contextual-data database; (iv) identifying UI elements in the UI page which are in an active state by operating event listeners. The identified UI elements may be added to the contextual-data database; (v) determining which module of the application is in an open state by tracking a Uniform Resource Locator (URL) of modules activated by the application and adding the determined module that is in open state to the contextual-data database; (vi) checking which UI elements are visible or active on the UI page that is presented on the display unit to be added to the contextual-data database; (vii) checking which UI elements, the user has been one of: hovering on and mouse-clicking during the preconfigured period of time to be added to the contextual-data database; and (viii) capturing data entered by the user into forms and text fields of the UI page during the preconfigured period of time to be added to the contextual-data database.

Furthermore, in accordance with some embodiments of the present disclosure, the one or more sources of information may be at least one of: (i) knowledge base; (ii) documentation; (iii) knowledge management platform; (iv) custom documentation notes; (v) Customer Relationship Management (CRM) systems.

There is further provided, in accordance with some embodiments of the present invention, one or more non-transitory, computer-readable media, storing instructions thereon that cause one or more processors to perform operations including: (i) receiving, by one or more processors from a user via a computerized-device, a query related to a User Interface (UI) page of an application, that is running on the computerized-device, and presented on a display unit associated to the computerized-device. The query is related to an operation of the application, by one or more elements of the UI; (ii) processing the received query by the one or more processors to yield position of the one or more UI elements related to the query on the UI page and a guidance in text-format of the one or more elements; and (iii) displaying the guidance as lingual-instructions of the operation of the application in text-format on the UI page and signaling the one or more UI elements related to the query with a visual cue on the UI page based on the position of each UI element in the one or more UI elements.

There is further provided, in accordance with some embodiments of the present invention, a computerized-system for large language model driven guidance of design and implementation of elements in a user interface. The computerized-system may include: at least one processor in communication with at least one non-transitory computer readable medium having software instructions stored thereon, wherein the at least one processor, upon execution of the software instructions, may be configured to: (1) receiving, by one or more processors from a user via a computerized-device, a query related to a User Interface (UI) page of an application, that is running on the computerized-device, and presented on a display unit associated to the computerized-device. The query is related to an operation of the application, by one or more elements of the UI; (ii) processing the received query by the one or more processors to yield position of the one or more UI elements related to the query on the UI page and a guidance in text-format of the one or more elements; and (iii) displaying the guidance as lingual-instructions of the operation of the application in text-format on the UI page and signaling the one or more UI elements related to the query with a visual cue on the UI page based on the position of each UI element in the one or more UI elements.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a high-level diagram of a computerized-system for large language model driven guidance of design and implementation of elements in a user interface, in accordance with some embodiments of the present invention;

FIG. 2 schematically illustrates a high-level diagram of a computerized-method for large language model driven guidance of design and implementation of elements in a user interface, in accordance with some embodiments of the present invention;

FIG. 3 schematically illustrates a high-level architecture diagram of a computerized-system large language model driven guidance of design and implementation of elements in a user interface, in accordance with some embodiments of the present invention;

FIG. 4 schematically illustrates a high-level diagram of retrieval Augmented Generation (RAG) implementation, in accordance with some embodiments of the present invention;

FIG. 5 schematically illustrates a high-level workflow of large language model driven guidance of design and implementation of elements in a user interface, in accordance with some embodiments of the present invention;

FIG. 6 schematically illustrates a high-level workflow of large language model driven guidance of design and implementation of elements in a user interface, in accordance with some embodiments of the present invention;

FIG. 7 schematically illustrates a high-level workflow of query assessment module, in accordance with some embodiments of the present invention;

FIG. 8 schematically illustrates a high-level workflow of contextual information retrieval, in accordance with some embodiments of the present invention;

FIG. 9 schematically illustrates a high-level workflow of query knowledge base retrieval, in accordance with some embodiments of the present invention;

FIG. 10 schematically illustrates a high-level workflow of context creation and tokenization, in accordance with some embodiments of the present invention;

FIG. 11 schematically illustrates a high-level workflow of prompt generation with context, in accordance with some embodiments of the present invention;

FIG. 12 schematically illustrates a high-level workflow of token from text removal, text to audio conversion and final response to user, in accordance with some embodiments of the present invention;

FIG. 13 schematically illustrates a hardware diagram of large language model driven guidance of design and implementation of elements in a user interface, in accordance with some embodiments of the present invention;

FIG. 14 schematically illustrates a high-level workflow of context scoring and relevance ranking, in accordance with some embodiments of the present invention;

FIG. 15 schematically illustrates a high-level workflow of token placement optimization, in accordance with some embodiments of the present invention;

FIGS. 16A-16B schematically illustrates a high-level workflow of tracking of actions executed by the user, in accordance with some embodiments of the present invention; and

FIGS. 17A-17I are examples of User Interfaces (UI) s for large language model driven guidance of design and implementation of elements in a user interface, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “User Interface (UI) page of an application”, as used herein refers to a graphical layout that users interact with to perform operations in an application. It includes UI elements that facilitates user interaction and navigation within the application. For example, buttons, which are interactive elements that users click to perform actions. Commonly, the buttons are placed in positions, such as the center or bottom of the screen. Text may be placed above or near related UI elements. Form fields are UI elements which are input areas where users can enter data, such as text boxes, checkboxes and radio buttons.

In user interface design, an activated state highlights which item from a set of options is currently selected or being viewed. This helps users understand their current position within the interface and navigate more easily.

UI documentation serves as a comprehensive guide that provides detailed information about the UI design and its implementation. The UI documentation may include among other things, design principles and guidelines, UI elements library that includes description of UI elements, such as buttons, forms, and navigation elements and guidelines of their usage. Additionally, it may include visual design specifications, such as color schemes, typography, iconography, and layout structure, which provide insights into the overall aesthetic and user experience. It may also encompass interaction patterns of UI elements in different contexts, e.g., hover states, form validation, error messages. Also, component states and transitions describing how UI elements behave in different states, e.g., active, disabled, selected, or focused and the transitions between these states.

The term “UI context”, as used herein, refers to the page that the user is currently viewing, along with the type of information present in the UI page and personal context of the user based on the user role or attribute information. The context encompasses the user's location in the application and tracks the actions taken, e.g., clicking a button or filling out a form and also considers the active UI elements the user is interacting with, such as buttons or text fields, which may relate to their current actions.

Current solutions for user help when using User Interface (UI) elements of an application embed insecure JavaScript code into the application which may entail a high configuration effort. Therefore, there is a need for a technical solution that may enhance interaction of the user with the UI through integrated visual and lingual cues by using LLM to generate dual-layered responses.

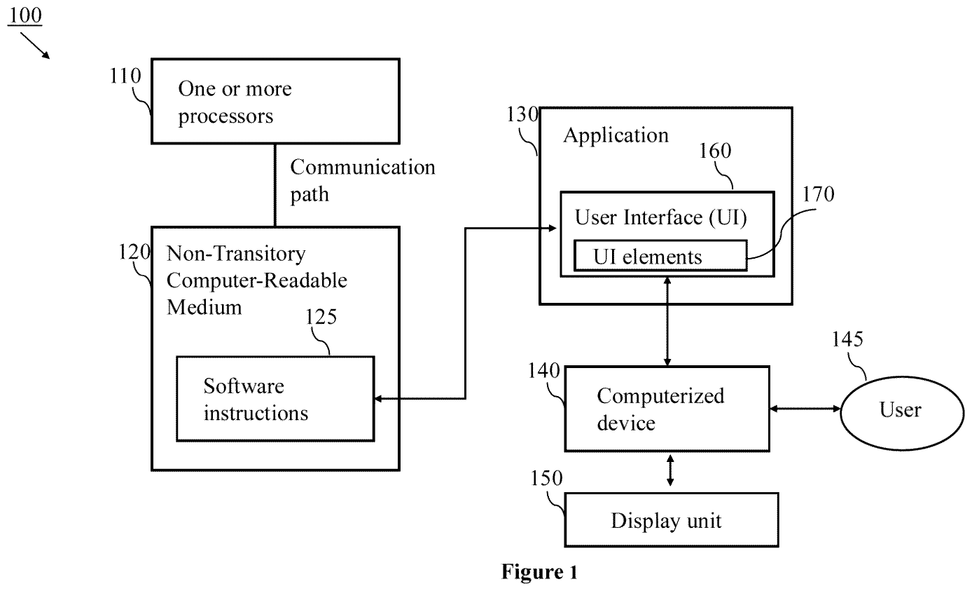

FIG. 1 schematically illustrates a high-level diagram of a computerized-system 100 for large language model driven guidance of design and implementation of elements in a user interface, in accordance with some embodiments of the present invention.

According to some embodiments of the present disclosure, when a query is received via the UI 160 it may be logged, processed by the assessment module and context retrieval module and then passed to an LLM, such as OpenAI model along with context from OpenSearch The query may be analyzed and matched against documents in an Elasticsearch index to find the most relevant UI guidance.

According to some embodiments of the present disclosure, the LLM, such as OpenAI API may generate a response based on the retrieved document summary and tokens that represent UI elements and actions. This process uses a Retrieval-Augmented Generation (RAG) approach, where the document retrieved from OpenSearch enhances the AI's ability to generate a relevant and precise response.

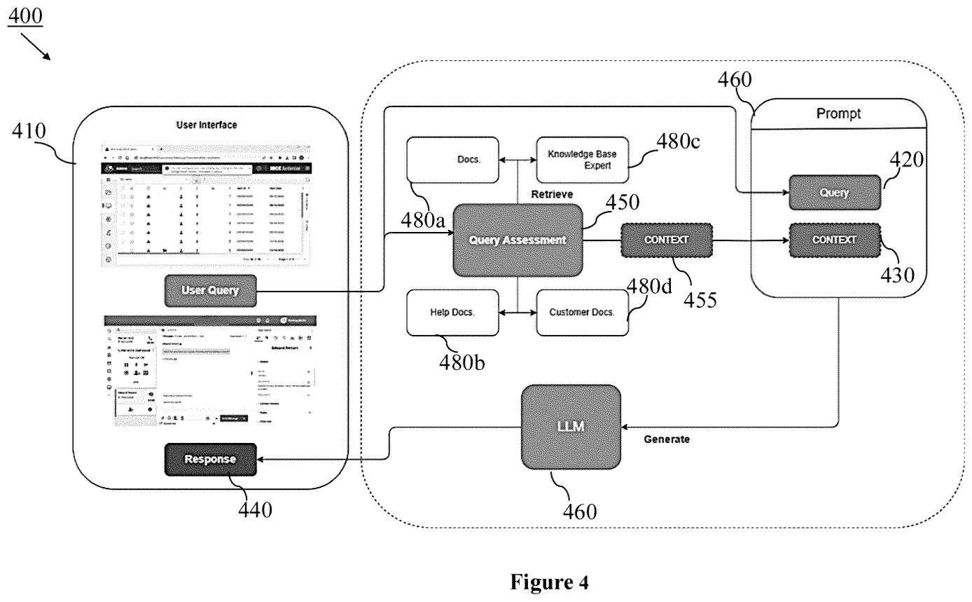

According to some embodiments of the present disclosure, the LLM, such as the OpenAI API, and such as LLM 460 in FIG. 4 may generate a response based on the retrieved document summary and tokens representing UI elements and actions. This process leverages a Retrieval-Augmented Generation (RAG) approach, where the document retrieved from OpenSearch is used to enrich the AI's ability to generate a more accurate and contextually relevant response. For example, as shown in FIG. 4. The retrieved document provides additional context that helps guide the AI in generating responses that are not only informed by the tokens but also aligned with the specific content and structure of the UI.

According to some embodiments of the present disclosure, the RAG approach combines both retrieval, fetching relevant documents and generation, creating a response, thus enabling the LLM to use external information, retrieved from OpenSearch to improve the relevance and accuracy of its output.

According to some embodiments of the present disclosure, the OpenSearch is a search engine that helps retrieve relevant documents to support the AI's response generation.

According to some embodiments of the present disclosure, errors may be logged at various stages and return error messages to the client, ensuring robustness and reliability.

According to some embodiments of the present disclosure, computerized-system 100 may formulate a response that includes detailed, structured instructions on how to address the user's query, ensuring the guidance is practical and easily understandable. The UI elements which are related to the instructions may be identified, and corresponding actionable tokens may be generated to facilitate direct interaction with the application's UI elements.

According to some embodiments of the present disclosure, the LLM, such as OpenAI may return a JavaScript Object Notation (JSON) object which may include two main components a message and a UI guidance. The message may be a detailed, formatted string providing a step-by-step guide to address the query, for example, about checking billing issues and reviewing charges. This guide may include for example, login steps, directions to navigate to the billing dashboard, instructions on how to review charges and identify issues, steps to escalate any issues found and advice on following up on the escalated issues.

According to some embodiments of the present disclosure, the UI guidance may be implemented as an array of objects, each representing a UI element and the corresponding action recommended in the step-by-step guide. These are tokens that correspond to actual interactive components in the UI 160. For example, [BTN_BILLING] which is a token suggesting an action to open the Billing Dashboard, [BTN_REVIEW], which is a token suggesting an action to review charges and [BTN_ESCALATE], which is a token suggesting an action to escalate an issue.

According to some embodiments of the present disclosure, the LLM may be integral to providing a virtual assistant-like experience, guiding users through specific tasks within the application 130 environment. The response may not only include narrative instructions, but also may integrate UI elements directly, enhancing interactivity and ensuring users can navigate complex interfaces more effectively. Thus, minimizing errors and improving user satisfaction by directly supporting users in accomplishing tasks they might find challenging.

According to some embodiments of the present disclosure, the query may be processed by interfacing with underlying services like OpenAI and Elasticsearch e.g., OpenSearch, where necessary context and data are retrieved to understand and respond accurately. The response generation may be augmented by retrieval-augmented techniques to pull relevant information and craft a response that is context-aware and highly pertinent to the user's request.

According to some embodiments of the present disclosure, a system, such as computerized-system 100 may provide Large Language Model (LLM) guidance of design and implementation of elements in a UI 160, when a user request help on how to use a particular function via the UI 160. The LLM driven guidance in computerized-system 100 may be generated from a personalized and informative response along with relevant unique tokens received from the LLM.

According to some embodiments of the present disclosure, one or more processors 110 may be in communication with at least one non-transitory computer readable medium 120 having software instructions stored thereon. The one or more processors 110, upon execution of the software instructions 125, may be configured to perform the following operations.

According to some embodiments of the present disclosure, the computerized-system 100 may receive by the one or more processors 110, from a user 145, a query related to a User Interface (UI) page of an application 130, that is running on a computerized-device 140 and presented on a display unit 150 associated to the computerized-device 140. The query may be related to an operation of the application 130, by UI elements 170 of the UI 160.

According to some embodiments of the present disclosure, the query may be received from the user 145 by keyboard input via a keyboard associated to the computerized device 140 or the query may be received via voice input, via a hardware device, such as microphone which captures the user's voice and converts it into an electrical signal that the computer can process. When the query is received by the voice input, the voice input may be converted into text by using a speech-to-text tool. The speech-to-text tool may analyze the digital audio data and may convert it into text or commands that the computer can understand. For example, Microsoft's Cortana®, Google Assistant®, Amazon Alexa®, and Apple's Siri®. For the actual real-time speech to text conversion speech-to text services may be used, such as Azure speech-to-text, Amazon Transcribe, IBM Watson speech to text.

According to some embodiments of the present disclosure, the one or more processors 110, may process the received query to yield position of each element in the UI elements 170 related to the query on the UI page and a guidance in text-format.

According to some embodiments of the present disclosure, the processing of the query may include evaluating context of the query by transferring the query, by the one or more processors 110 to an assessment module and operating the assessment module, by the one or more processors 110.

According to some embodiments of the present disclosure, the processing of the query may include retrieving contextual guidance and a position of each UI element in the UI elements 170 by operating a context retrieval module based on the evaluated context of the query. The retrieved contextual guidance may be used to search in sources of information and retrieve guidance-information. The sources of information may be for example, knowledge base, documentation, knowledge management platform, custom documentation notes and Customer Relationship Management (CRM) systems.

According to some embodiments of the present disclosure, capturing UI context may be achieved through mechanisms embedded within the UI 160 that operate alongside the functionality responsible for capturing the user's query. For example, software designed to monitor and track the UI elements accessed by the user, dynamic applications that retrieve window names and screen titles in real-time, backend services that log and maintain a chronological record of UI contexts based on the user access requests and systems that track mouse movements or screen touches to capture a position of user interactions, e.g. X/Y coordinates.

According to some embodiments of the present disclosure, a module, such as an assessment module may prepare the query for an evaluation. The preparation of the query for the evaluation may include sanitizing the query to remove any irrelevant data, formatting it for evaluation, e.g., tokenization, standardizing input, and structuring it for further processing by downstream components. The preparation may further include parsing the input to identify its structure and breaking it into manageable parts, such as sentences, phrases, or tokens.

According to some embodiments of the present disclosure, the assessment module may further determine a type of guidance by analyzing the prepared query and then may identify keywords, phrases and complexity of the query, by operating pretrained machine learning models, such as GPT or Hugging Face Transformers®, ElasticSearch® with Natural language processing (NLP), the pretrained LLM which can process the query by leveraging its pretrained NLP capabilities to identify keywords, phrases, and assess complexity.

According to some embodiments of the present disclosure, the complexity of the query may include factors, such as clarity, how direct or ambiguous the query is, length, longer structures or compound sentences may indicate greater complexity of the query, and intent layers, which is whether the query involves multiple intents or requires a nested logic.

According to some embodiments of the present disclosure, the keyword and phrase extraction may be identified by tokenizing the query and processing it to identify significant words or phrases. For example, for the query “How do I reset my password in the admin dashboard?”, the pretrained machine learning models may identify keywords, such as “reset password” and “admin dashboard”.

According to some embodiments of the present disclosure, for example, the following prompt may be generated, “analyze the following user query: extract keywords and phrases. Determine the level of complexity based on intent, length and context requirements. Query: “how do I reset my password in the admin dashboard?”, the response may be “Keywords: “reset password”, “admin dashboard”, Complexity: Low. The query is direct and self-contained, requiring minimal additional context”.

According to some embodiments of the present disclosure, the assessment module may determine a source of response to the query and priority level based on the identified keywords, phrases and complexity of the query and then send the source of response, the type of guidance, and the priority level as the evaluated context of the query to the context retrieval module. The type of guidance may be for example, technical issue, user manual request, troubleshooting assistance, configuration support, error message clarification, warning message clarifications, and feature explanation, providing details about how a particular feature, tool, or functionality works, including use cases and potential applications.

According to some embodiments of the present disclosure, a module, such as a context retrieval module may receive the evaluated context of the query and then identify a position of the UI element to be added to a contextual-data database. The contextual retrieval module may analyze recorded actions of the user during a preconfigured period of time to yield data related to the UI page to be added to the contextual-data database and then identify UI elements in the UI page which are in an active state by operating event listeners. The identified UI elements may be added to the contextual-data database.

According to some embodiments of the present disclosure, the evaluated context of the query may include contextual metadata, query classification, priority level, historical data and actionable insights. The contextual metadata of the query may be the information about the user's current state, such as the active UI page, recent actions or location within the system. The type of query may be for example, informational, troubleshooting or task oriented. The priority level of the query may indicate the urgency or importance of the query based on identified keywords and context.

According to some embodiments of the present disclosure, historical data may include insights from previous interactions with the system. Actionable insights may be suggestions for further refinement or escalation if needed.

According to some embodiments of the present disclosure, the context retrieval module may determine which module of the application is in an open state by tracking a Uniform Resource Locator (URL) of modules activated by the application and adding the determined module that is in open state to the contextual-data database and then check which UI elements are visible or active on the UI page that is presented on the display unit to be added to the contextual-data database.

According to some embodiments of the present disclosure, the context retrieval module may check which UI elements, the user has been hovering on or mouse-clicking during the preconfigured period of time to be added to the contextual-data database, and then capture data entered by the user into forms and text fields of the UI page during the preconfigured period of time to be added to the contextual-data database.

According to some embodiments of the present disclosure, behavioral patterns, interaction trends and contextual data may be generated by the context retrieval module. User events may be continuously tracked, for example, mouse-clicks, hovers, and inputs, along with metadata, such as timestamps and session IDs which are stored in the contextual-data database. The user profiles, session histories, aggregated trends, and inferred intents may be also stored in the contextual-data database.

According to some embodiments of the present disclosure, user events, e.g. user interactions with UI elements such as clicks, hovers, focus, or form inputs may be detected by event listeners in the UI framework, such as JavaScript®, React®, Angular®. For example, monitor onclick, onfocus, onchange, or onmouseover events to determine which UI elements are currently active.

According to some embodiments of the present disclosure, the Document Object Model (DOM) may be used to query and inspect the state of UI elements in real-time. Methods in JavaScript, like document.activeElement can identify the UI element that is currently in focus, for example, an input field or button. Cascading Style Sheets (CSS) classes or attributes, for example, class=” active” or aria-selected= “true”, can also indicate the active state of the UI elements.

According to some embodiments of the present disclosure, state management tools provided by UI frameworks, for example, React's state, Angular's data binding may be utilized to track which UI elements are active.

According to some embodiments of the present disclosure, the data from the contextual-data database may be analyzed using event tracking and logging, time-series analysis, NLP, and other tools. Data may be captured directly from the input elements, for example as the user types into a text box. The data may be name, ID, or label of the field, and timestamp of data input.

According to some embodiments of the present disclosure, to determine the currently open module of the application 130, the URL or route, e.g., dashboard, settings, may be tracked to identify the active module. The Document Object Model (DOM) may be inspected for module-specific elements, such as container IDs or active classes, and state management tools may be utilized to retrieve the current application state.

According to some embodiments of the present disclosure, the data gathered in the contextual-data database may be used to create context of the query and perform tokenization. It enables to provide context-aware responses for the UI guidance. It is also used to query the knowledge base by passing the user's query along with the generated context as input.

According to some embodiments of the present disclosure, each UI element is associated an element ID that reflects the position of the UI element on the UI page and can be used to create interactions that affect the UI page. For example, when clicking a button in the UI page, the button may be identified by the element ID and the user click may trigger a function in the application.

According to some embodiments of the present disclosure, the LLM may be trained by mapping predefined IDs of elements of the UI to text labels by using a UI tool and then analyzing a hierarchy of the elements of the UI and respective position in the UI page, leveraging the predefined ID for each element in the elements of the UI, by using the UI tool. It may leverage the predefined IDs to associate UI elements with their structural and positional context within the UI page. By analyzing the hierarchy of the elements of the UI, the LLM gains a deeper understanding of how UI elements are grouped or related, enabling it to provide context-aware guidance and responses.

According to some embodiments of the present disclosure, during the training, the LLM may be further provided a mapping document that links keywords and phrases to UI elements of the UI page and then a product documentation of the application to be ingested by the LLM based on descriptive information of the elements of each UI page.

According to some embodiments of the present disclosure, the UI elements may be associated IDs by one of the following implementations. A graphical interface tool may map predefined IDs to all UI elements in the UI page to their corresponding text labels or tooltips. Alternatively, the graphical interface tool may analyze the hierarchy of UI elements and generate unique IDs for the UI element incorporating their labels and location properties. In another option, a manually mapping document may be created, in a format, such as text, comma-separated values (CSV), Portable Document Format (PDF), Excel spread sheet, or JavaScript Object Notation (JSON), which may link keywords and phrases to UI element IDs.

According to some embodiments of the present disclosure, the UI elements may be further associated IDs by the ingestion of the application product documentation by the LLM, where label and section declarations serve as the foundation for generating unique IDs based on the descriptive information contained within the document.

According to some embodiments of the present disclosure, the UI context may be determined based on an analysis of the guidance-information. The UI context may include currently viewed UI page, actions operated via the UI page, related user-input, active UI elements and details of the user.

According to some embodiments of the present disclosure, additional sources for training the LLM may be for example, the application logs and user interaction data, which provide insights into real-world usage patterns and user behavior, knowledge bases, which offer domain-specific information and solutions to common queries.

According to some embodiments of the present disclosure, other examples of sources for training the LLM may be annotated training data, consisting of labeled examples for supervised learning, localization data, enabling multilingual adaptability by incorporating translations of UI elements, and ontology or taxonomy of domain terms, which establish relationships between specialized terms and concepts to enhance contextual understanding. These sources may ensure a well-rounded and effective training process for the LLM.

According to some embodiments of the present disclosure, the UI elements related to the query may be identified based on the UI context and generating a token for each UI element in the UI elements, with metrics of the UI element. The metrics may include an assigned name of the UI element and the position of the UI element on the UI page. The assigned name of each UI element may be embedded in the guidance in text-format.

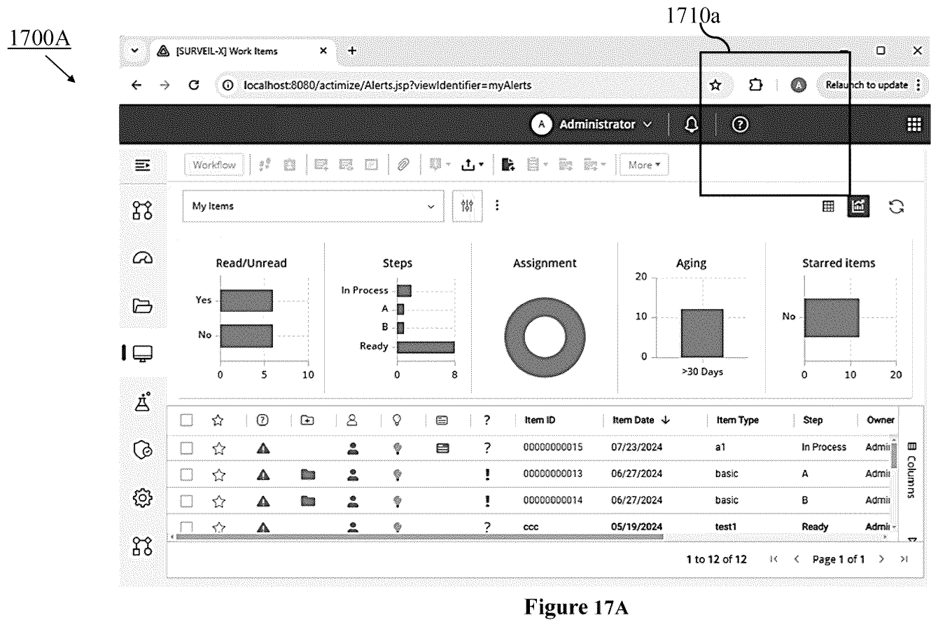

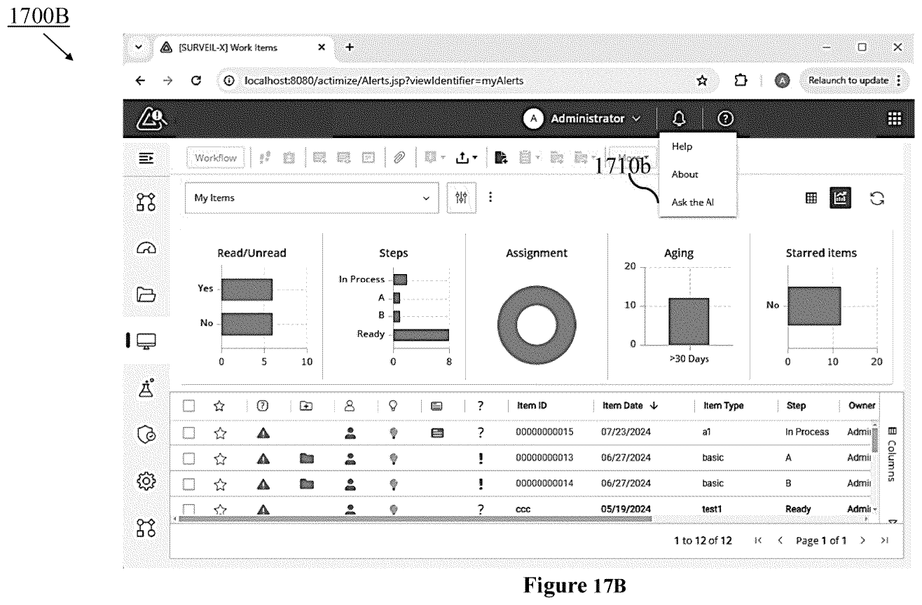

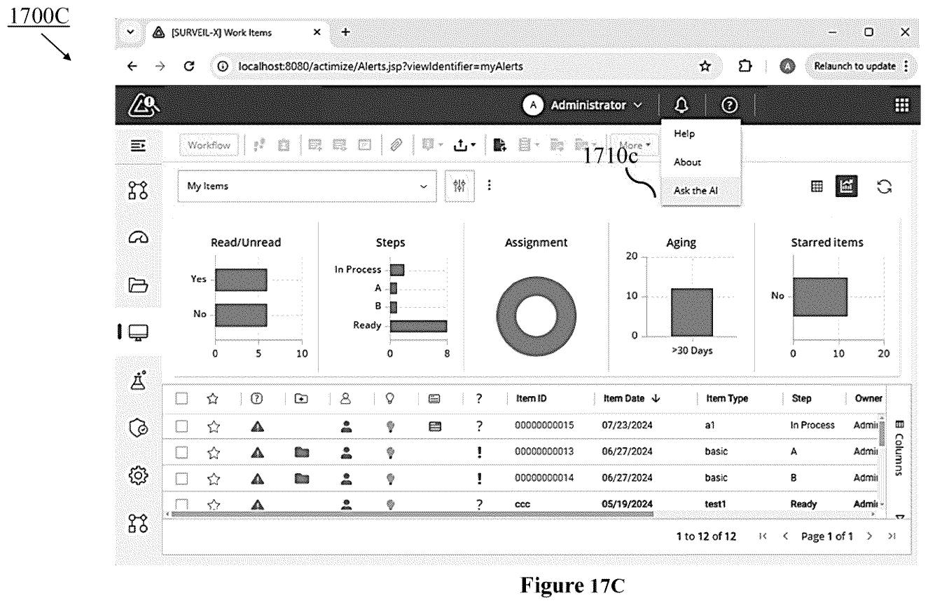

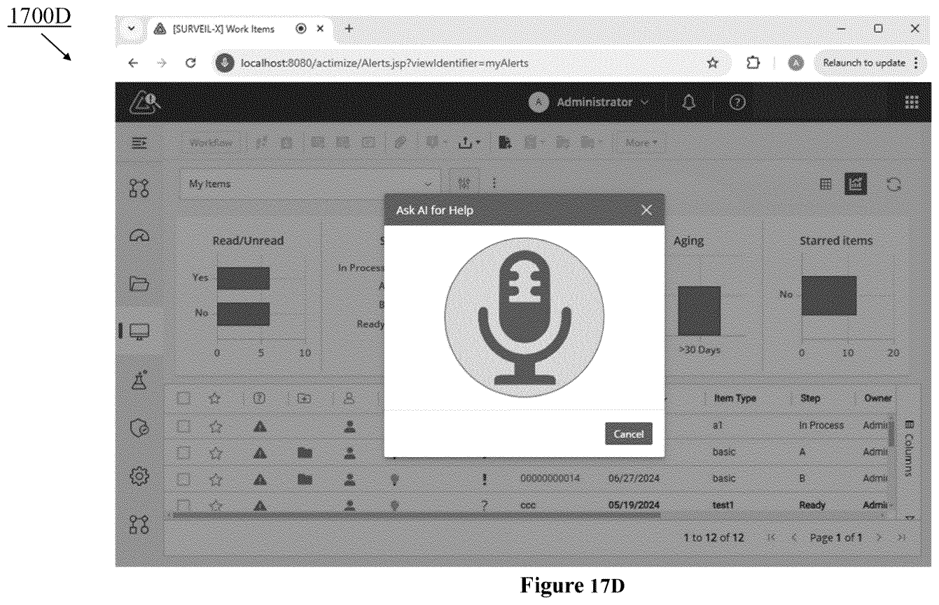

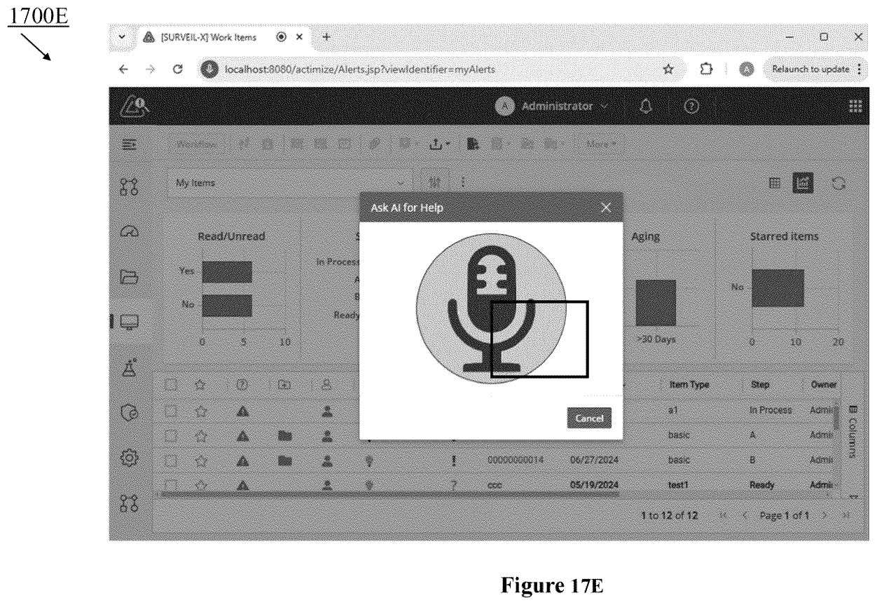

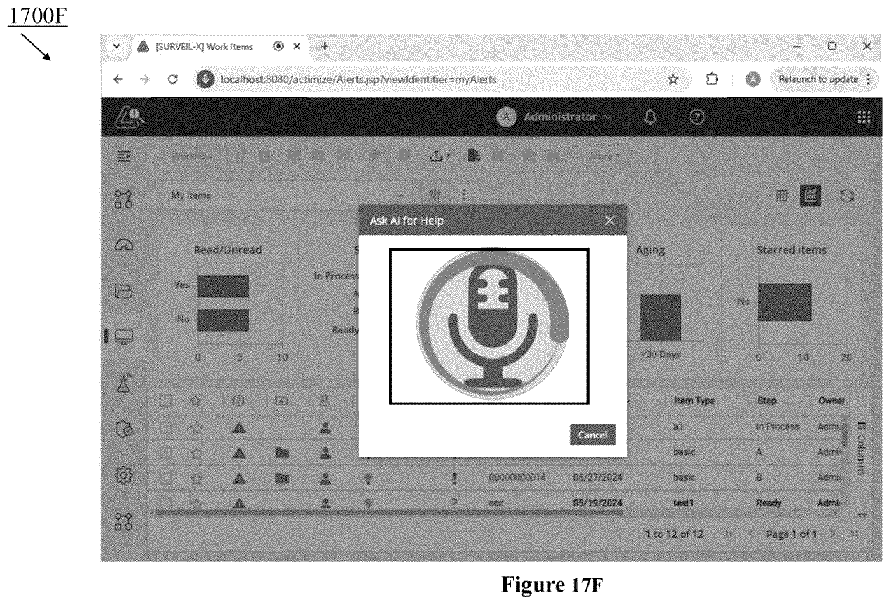

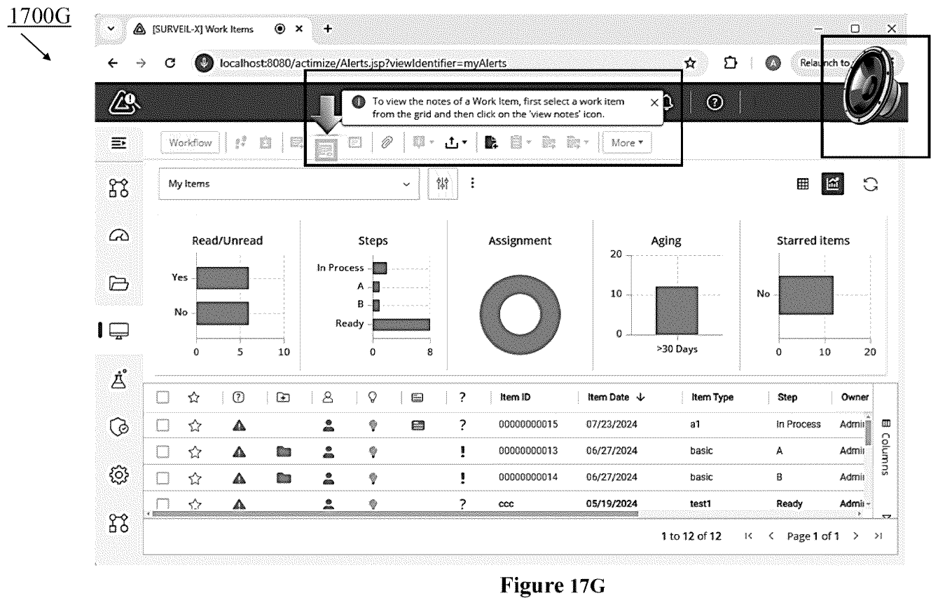

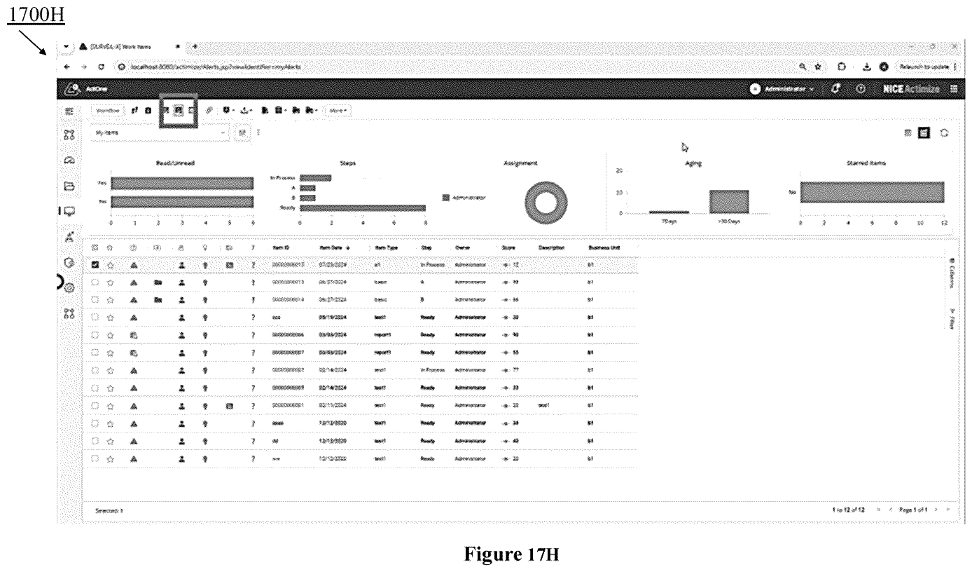

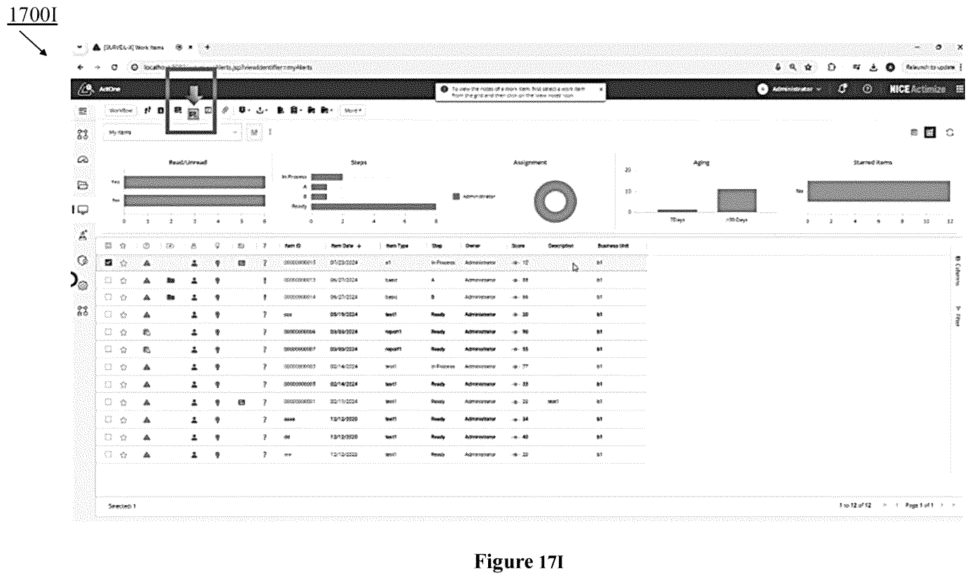

According to some embodiments of the present disclosure, the guidance, which is the response to the user's query, may be displayed as lingual-instructions of the operation of the application in text-format on the UI page and signaling the UI elements 170 related to the query with a visual cue on the UI page based on the position of each UI element in the UI elements 170. For example, as shown in FIG. 17G.

According to some embodiments of the present disclosure, computerized-system 100 may integrate informative documentation with an LLM trained to embed unique tokens corresponding to specific UI elements and positions within the UI page of the application.

According to some embodiments of the present disclosure, when the user 145 may send a query on how to use a particular function, the query may be processed by an assessment module and a context module and then the query may be provided with the context as a prompt to an LLM which may provide a personalized, informative response along with relevant unique tokens. These tokens can be used by the application to interactively navigate or highlight the corresponding UI elements 170, providing the user 145 with visual direction that directly relates to the guidance received.

According to some embodiments of the present disclosure, system 100 may not only enhance the user's understanding and interaction with the application 130 by linking documentation to specific UI elements, but also enable an anonymous recording of unique tokens used in user prompts. These metrics may indicate areas where users face challenges, allowing for targeted improvements in the application's UI and overall user experience.

According to some embodiments of the present disclosure, computerized-system 100 may play voice-instructions of the operation in the application in audio-format, via an audio interface in the computerized-device 140. The voice-instructions may correspond to the lingual-instructions of the operation in the application in text-format.

According to some embodiments of the present disclosure, computerized-system 100 may monitor user's actions via the UI, by the one or more processors 110, to calculate number of queries related to each operation of each UI element in each UI page of the application during a preconfigured time.

According to some embodiments of the present disclosure, a report may be generated with a preconfigured number of UI elements having highest number of queries. The report may be displayed via the display unit 150.

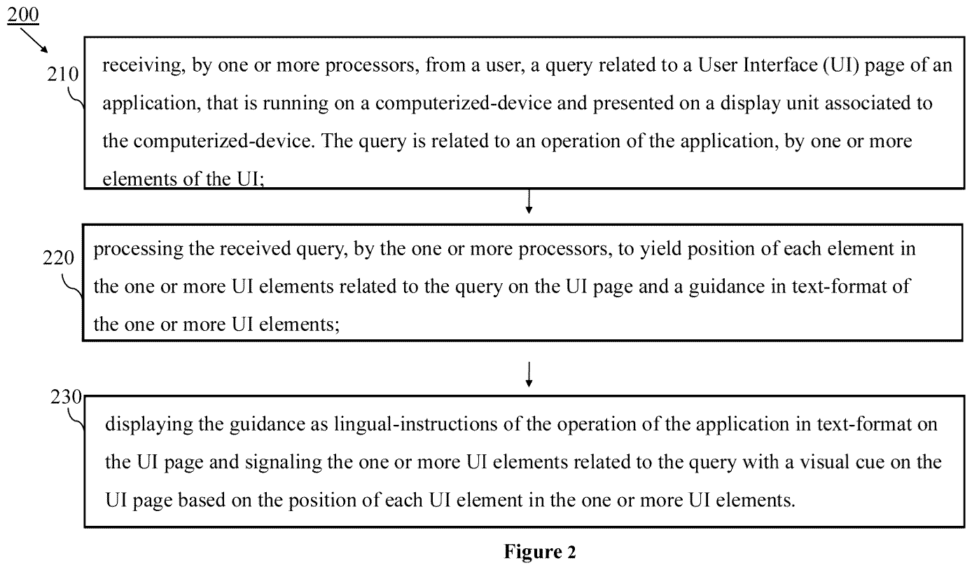

According to some embodiments of the present disclosure, computerized-system 100 may implement a method, such as computerized-method 200 in FIG. 2 for large language model driven guidance of design and implementation of elements in a user interface.

According to some embodiments of the present disclosure, computerized-system 100 may be integrated within the application framework, thus eliminating the need for external software or plug-ins. Instead of manually configuring guidance for every UI page of the application, the computerized-system 100 may adapt to the underlying application, providing real-time and context-aware support to users as they navigate through the product.

According to some embodiments of the present disclosure, computerized-system 100 may enable users to research how to use a feature, by a UI element, thus simplifying training and reducing the cost of new onboarding new users. The UI elements 170 may be connected to documentation to learn how to configure or implement a feature. An increase in implementation knowledge can lead to higher feature adoption rates and product stickiness.

According to some embodiments of the present disclosure, computerized-system 100 may collect metrics on usage and features where clients prompt the most questions which can indicate feature popularity or confusion, tenant needs to target end-user training in a specific area, feature documentation revision, incorrect implementation of feature and need for correction, the need for a feature enhancement to close product gaps and/or support additional use cases, and market feedback to support upcoming product roadmap decisions.

According to some embodiments of the present disclosure, for example, a user 145 may send a question “how do I change my score?” via keyboard input when the user 145 may type the query or alternatively via voice input when the user 145 may speak the query and later on the audio may be converted to text using speech-to-text.

According to some embodiments of the present disclosure, the assessment module may evaluate the user's input to determine what information or assistance is being requested. the assessment module may send the query to the context retrieval module to retrieve contextual information and understand the user's current state in the application 130.

According to some embodiments of the present disclosure, additional context may be gathered to help refine the search or response. For example, the user's current location in the UI 160, previous actions taken by the user, specific UI elements currently being interacted with a specific module or section of the application 130, e.g., account settings, dashboard, the particular page or dialog box that is open, the UI elements that are visible or active on the screen, e.g., buttons, text fields, menus, buttons, links, or icons that the user is hovering over or has clicked, forms or text fields where the user is entering information, and drop-down menus or settings that the user is currently navigating

According to some embodiments of the present disclosure, computerized-system 100 may query the knowledge base to find relevant information based on the user's input and the contextual information gathered. For example, the application's documentation, the tenant custom documentation of the application, internal documentation of the CRM system and Frequently Asked Questions (FAQ) s, help documentation and the like.

According to some embodiments of the present disclosure, computerized-system 100 may create context for the retrieved information and applies tokenization. Tokenization may include generating unique tokens that correspond to specific UI elements or actions. These tokens can then be used to guide the user to the correct part of the interface.

According to some embodiments of the present disclosure, for example, for the user query “How do I reset my password?”, computerized-system 100 may create context by retrieving information on password resetting procedures and recognizes that the user is currently on the account settings page. Then, operating the tokenization by identifying the “Reset Password” button and the confirmation dialog as key UI elements, generating tokens [BTN_RESET_PASSWORD] and [CONFIRM_DIALOG].

According to some embodiments of the present disclosure, computerized-system 100 may generate response as the guidance and display the guidance as lingual-instructions of the operation of the application in text-format on the UI page and may signal the UI elements related to the query with a visual cue on the UI page based on the position of each UI element in the UI elements. For example, as shown in FIG. 17G.

According to some embodiments of the present disclosure, the generated response may be for example, “To reset your password, click on password reset [BTN_RESET_PASSWORD] and then confirm in the confirmation box [CONFIRM_DIALOG].” The “Reset Password” button may be highlighted, and the confirmation dialog may be automatically brought up when the user clicks on the confirmation box.

According to some embodiments of the present disclosure, computerized-system 100 may generate a prompt or response based on the retrieved information and the created context. The response may include the unique tokens that will help the user navigate the application's UI elements. The LLM may create the response using retrieved information and context. Unique tokens may be embedded in the response to link to specific UI elements. The response may be tailored to the user's current context and is actionable. The response may be presented in natural language with tokens ready for UI interpretation. The tokens may guide the computerized-system 100 to highlight or navigate UI elements on the UI page for the user.

According to some embodiments of the present disclosure, before delivering the final response to the user, the tokens may be translated into UI references, such as highlighting or navigating to a button and metrics e.g., tracking user interaction with these elements.

According to some embodiments of the present disclosure, the translation of the tokens to UI references may bridge the output generated by the LLM with the UI page. The response generated by the LLM contains tokens that represent specific actions or UI elements. A predefined mapping is established between tokens and UI elements. The mapping may be implemented through a variety of methods, such as by maintaining a dictionary or mapping table that links specific tokens, e.g., “submit button” to specific UI elements, e.g., <button id= “submitBtn”>Submit</button>. Another method may be by leveraging information from the UI documentation, where each UI element is documented with identifiers IDs, class names, or data attributes. It may be implemented by an API that matches tokens to corresponding UI elements in the DOM based on this documentation and a dynamic Element Search, for elements that might not have static identifiers, DOM queries, e.g., querySelector or getElementById, may be used to dynamically search for elements that match keywords or phrases associated with the tokens.

According to some embodiments of the present disclosure, optionally, when user preference has been configured to audio response, computerized-system 100 may automatically convert the generated text in the response into speech and then play the audio file with the response to the user's query.

According to some embodiments of the present disclosure, computerized-system 100 may deliver the final response to the user, in text or in audio form, which may include guidance on what actions to take in the application 130, via the UI 160.

According to some embodiments of the present disclosure, computerized-system 100 may be implemented in each application that the users require a fast and intuitive way to interact with it to perform tasks or retrieve information without traditional manual navigation.

According to some embodiments of the present disclosure, via the implementation of computerized-system 100, users can use voice commands to navigate customer service interfaces. For example, a user might say, “Show me all open customer tickets from today.” The system would use speech-to-text conversion to interpret the command, fetch the relevant data, and display it on the user's screen. If the user then says, “Close ticket number 1023,” the system can automatically perform this action after confirming the command with the user.

According to some embodiments of the present disclosure, via the implementation of computerized-system 100 in a fraud management context, users might use voice commands to query transaction histories or flag transactions. For instance, saying, “Flag the latest transaction on account 456 as suspicious,” could trigger the system to automatically update the transaction status after user verification, streamlining the fraud management process.

According to some embodiments of the present disclosure, the implementation of computerized-system 100 may provide automated responses to common inquiries through voice interaction. When a user asks, “How do I reset my password?” the system may guide them through the steps using voice. If the user consents to an automatic reset, the system may execute these steps directly, such as navigating to the reset page and entering preliminary information, thus, enhancing the self-service experience.

FIG. 2 schematically illustrates a high-level diagram of a computerized-method 200 for large language model driven guidance of design and implementation of elements in a user interface, in accordance with some embodiments of the present invention.

According to some embodiments of the present disclosure, operation 210 comprising receiving, by one or more processors, from a user, a query related to a User Interface (UI) page of an application, that is running on a computerized-device and presented on a display unit associated to the computerized-device. The query is related to an operation of the application, by one or more elements of the UI

According to some embodiments of the present disclosure, operation 220 comprising processing the received query, by the one or more processors, to yield position of each element in the one or more UI elements related to the query on the UI page and a guidance in text-format of the one or more UI elements.

According to some embodiments of the present disclosure, operation 230 comprising displaying the guidance as lingual-instructions of the operation of the application in text-format on the UI page and signaling the one or more UI elements related to the query with a visual cue on the UI page based on the position of each UI element in the one or more UI elements.

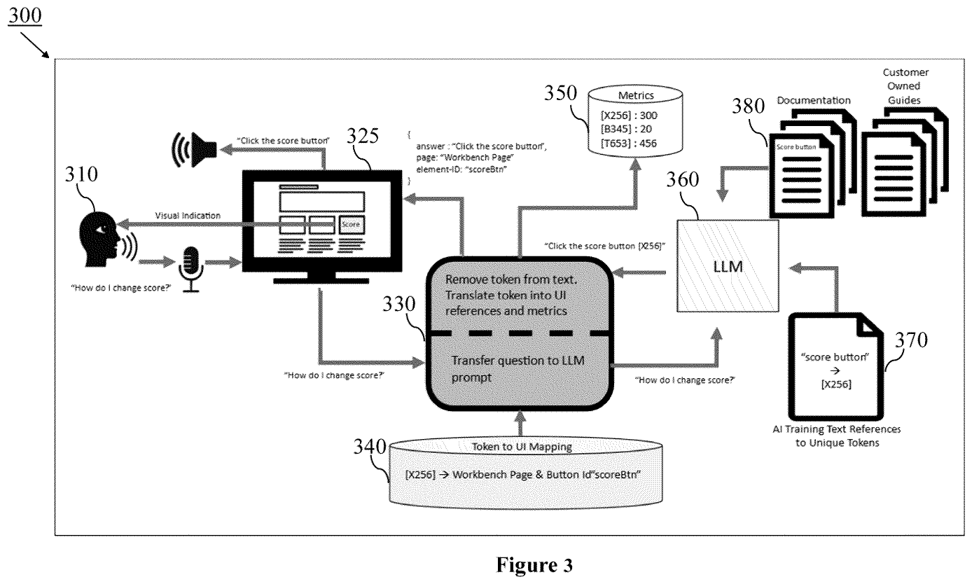

FIG. 3 schematically illustrates a high-level architecture diagram 300 of a computerized-system large language model driven guidance of design and implementation of elements in a user interface, in accordance with some embodiments of the present invention.

According to some embodiments of the present disclosure, in a system, such as computerized-system 100 in FIG. 1, a user 310 may move the mouse over the “Ask the AI”, for example, as shown in FIG. 17C, and may click on it which may start the process to interact with the LLM for resolving a user query.

According to some embodiments of the present disclosure, the user 310 may query “How do I change score?”. The query may be received by keyboard input or by voice input. When the query is received by the voice input, the computerized-system 100 in FIG. 1 may further convert the voice input into text by using a speech-to-text tool.

According to some embodiments of the present disclosure, the received query, may be processed, to yield the position of each element in the UI elements related to the query on the UI page and a guidance in text-format of the UI elements.

According to some embodiments of the present disclosure, the query may be evaluated by a module, such as an assessment module 330 which may receive the query and transfer it to the LLM 360 as a prompt to receive a tokenized response. The tokenized response may help the user navigate the application's UI elements. The LLM may create the response by using retrieved information and context. Unique tokens may be embedded in the response to link to specific UI elements.

According to some embodiments of the present disclosure, the assessment module may prepare the query for an evaluation and then determine a type of guidance by analyzing the prepared query. Keywords, phrases and complexity of the query, may be identified by operating pretrained machine learning models. The complexity of the query may include factors, such as clarity, how direct or ambiguous the query is, length, longer structures or compound sentences may indicate greater complexity of the query, and intent layers, whether the query involves multiple intents or requires a nested logic.

According to some embodiments of the present disclosure, a source of response 380 to the query and priority level based on the identified keywords, phrases and complexity of the query may be determined by assessment module as well as the type of guidance, and the priority level may be sent as the evaluated context of the query to the context retrieval module.

According to some embodiments of the present disclosure, the source of response 380 may be for example, applications documentation descriptive information of the elements of each UI page, the customer owned guides, knowledge management platform, custom documentation notes, and Customer Relationship Management (CRM) systems.

According to some embodiments of the present disclosure, the LLM 360 may be trained on text references of the UI elements, such as “score button” to provide a unique token “[X256 UI element ID. [X256] may be mapped into the UI page workbench page and the name of the button ID “ScoreBtn”. This mapping may be stored in a token to UI mapping database 340

According to some embodiments of the present disclosure, the assessment module 330 may remove tokens from the text provided by the LLM 360 and translate the token into UI references and metrics based on data retrieved from the contextual-data database 350.

According to some embodiments of the present disclosure, the data in the contextual-data database 350 may be added to the contextual-data database 350 by a module, such as context retrieval module. The context retrieval module may receive the evaluated context of the query which has been created by the assessment module 330, during the processing of the query.

According to some embodiments of the present disclosure, the context retrieval module may identify a position of the UI element to be added to the contextual-data database 350 and may analyze recorded actions of the user during a preconfigured period of time to yield data related to the UI page which may be also added to the contextual-data database 350.

According to some embodiments of the present disclosure, the context retrieval module may identify UI elements in the UI page which are in an active state by operating event listeners and may store the identified UI elements in the contextual-data database 350. The contextual retrieval module may further determine which module of the application is in an open state by tracking a Uniform Resource Locator (URL) of modules activated by the application and adding the determined module, that is in open state, to the contextual-data database 350.

According to some embodiments of the present disclosure, the context retrieval module may further check which UI elements are visible or active on the UI page that is presented on the display unit 325 and may add it to the contextual-data database 350.

According to some embodiments of the present disclosure, the context retrieval module may check which UI elements the user has been either hovering on or mouse-clicking during the preconfigured period of time and store it in the contextual-data database 350. The context retrieval module may capture data entered by the user into forms and text fields of the UI page during the preconfigured period of time and store it in the contextual-data database 350.

According to some embodiments of the present disclosure, contextual guidance and a position of each UI element in the UI elements may be retrieved from the contextual-data database 350, based on the evaluated context. The retrieved contextual guidance may be used to search the sources of response 380 and retrieve guidance-information.

According to some embodiments of the present disclosure, UI context of the query may be determined based on analysis of the guidance-information. The UI context may include currently viewed UI page, actions operated via the UI page, related user-input, active UI elements and details of the user.

According to some embodiments of the present disclosure, UI elements related to the query may be identified based on the UI context and generate a token for each UI element in the one or more UI elements, with metrics of the UI element, which may be stored in the contextual-data database 350. The metrics may include an assigned name of the UI element and the position of the UI element on the UI page.

According to some embodiments of the present disclosure, the assigned name of each UI element may be embedded in the guidance, e.g. response to the query, in text-format. For example, “click the score button”.

FIG. 4 schematically illustrates a high-level diagram 400 of retrieval Augmented Generation (RAG) implementation, in accordance with some embodiments of the present invention.

According to some embodiments of the present disclosure, in a system, such as computerized-system 100 in FIG. 1, the LLM 460 may generate a response to a user's query via the UI 410 based on retrieved information, contextual data, and tokens. This ensures the response is informative, addressing the user's needs by incorporating the context. Tokens corresponding to specific UI elements may be embedded in the response, tailoring it to the user's current activity via the application. The response may be finalized in natural language, with tokens prepared for UI interpretation, acting as direct links or guides to the relevant elements.

According to some embodiments of the present disclosure, The RAG approach may integrate external context from documents and data sources into the query processing flow, which enhances the LLM's ability to generate contextually appropriate and precise responses. The assessment module, such as query assessment module 450 may play a vital role in augmenting the user's input by retrieving relevant data, ensuring that the final response is not only generated but also contextually informed.

According to some embodiments of the present disclosure, the LLM relies on a retrieval mechanism that first queries the knowledge base and provides relevant context for response generation. The LLM generates a response based on both the original query and the retrieved contextual information.

According to some embodiments of the present disclosure, the system may retrieve relevant context for example, from docs 480a, Help Docs 480c, Knowledge Base Expert 480b, and Customer Docs 480d to augment the query 420 from the user with additional data, e.g., context 455. The query may be augmented with the context 455 to provide a rich and accurate context for generating the response. The augmentation may be performed by the query assessment module 450 which may enrich the query by using the retrieved context 455 and preparing it for the LLM 460 to provide it as a prompt with the query 420 and the context 430 to generate the response 440.

According to some embodiments of the present disclosure, the generation may be operated by the LLM 460 which may combine the original query with the retrieved information to produce a highly relevant, context-specific, and accurate response.

According to some embodiments of the present disclosure, the Retrieval-Augmented Generation (RAG) is the process of optimizing the output of the LLM, so it references an authoritative knowledge base outside of its training data sources before generating a response. The LLMs are trained on vast volumes of data and use billions of parameters to generate original output for tasks like answering questions, translating languages, and completing sentences. RAG extends the capabilities of LLMs to specific domains or an organization's internal knowledge base, all without the need to retrain the model. It is a cost-effective approach to improving LLM output, so it remains relevant, accurate, and useful in various contexts.

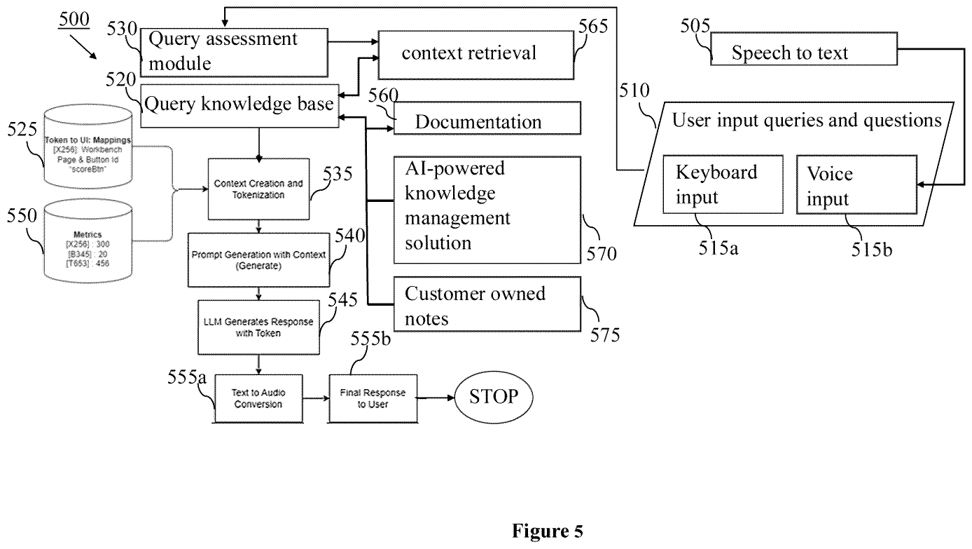

FIG. 5 schematically illustrates a high-level workflow 500 of large language model driven guidance of design and implementation of elements in a user interface, in accordance with some embodiments of the present invention.

According to some embodiments of the present disclosure, a user may require guidance as to usage of a feature in an application via a UI, for example, as shown in FIGS. 17A-17I. The user input queries and questions 510 may be via keyboard input 515a or voice input 515b which may be recorded into an audio file and converted into text by a speech-to-text 505 tool. The user query may trigger the operation of a system, such as system 100 in FIG. 1 and the text of the query may be forwarded to the query assessment module 530, such as assessment module 330 in FIG. 3.

According to some embodiments of the present disclosure, the query may be evaluated by the assessment module which may retrieve contextual guidance and a position of each UI element in the UI elements by operating the context retrieval module 565 based on the evaluated context of the query. The retrieved contextual guidance may be used to search in one or more sources of information, such as query knowledge base 520, documentation 560, AI-powered knowledge management solution 570 and customer owned notes and retrieve guidance-information.

According to some embodiments of the present disclosure, context creation and tokenization 535 may be operated by determining UI context based on an analysis of the guidance-information. The UI context may include currently viewed UI page, actions operated via the UI page, related user-input, active UI elements and details of the user.

According to some embodiments of the present disclosure, a prompt may be generated with context 540, such as prompt 460 in FIG. 4 and forwarded to the LLM which may generate response with tokens 545.

According to some embodiments of the present disclosure, the token may be generated with metrics of the UI element by identifying UI elements related to the query based on the UI context. The metrics may include an assigned name of the UI element and the position of the UI element on the UI page.

According to some embodiments of the present disclosure, the tokens may be removed from the text and replaced by translation of the tokens into UI references and metrics based on data from a database 525 with mapping of a UI element ID in the UI page into the name of the UI element. For example, UI element ID [X256] may be mapped into the UI page workbench page and the name of the button ID “ScoreBtn”.

According to some embodiments of the present disclosure, the database 525 may maintain a record of which UI elements are being frequently referenced or requested by users. This record may be used for tracking user queries related to UI components for future analysis, which can be used to improve system responses and user assistance.

According to some embodiments of the present disclosure, the metrics database 550, such as contextual-data database 350 in FIG. 3, may store mappings between tokens and UI elements present on the screen. These mappings enable the system to highlight or indicate UI elements dynamically in response to user queries, improving usability.

According to some embodiments of the present disclosure, the assigned name of each UI element may be embedded in the response in text-format. Optionally, the response in text-format may be converted into audio file 555a and may be played as the final response to the user 555b.

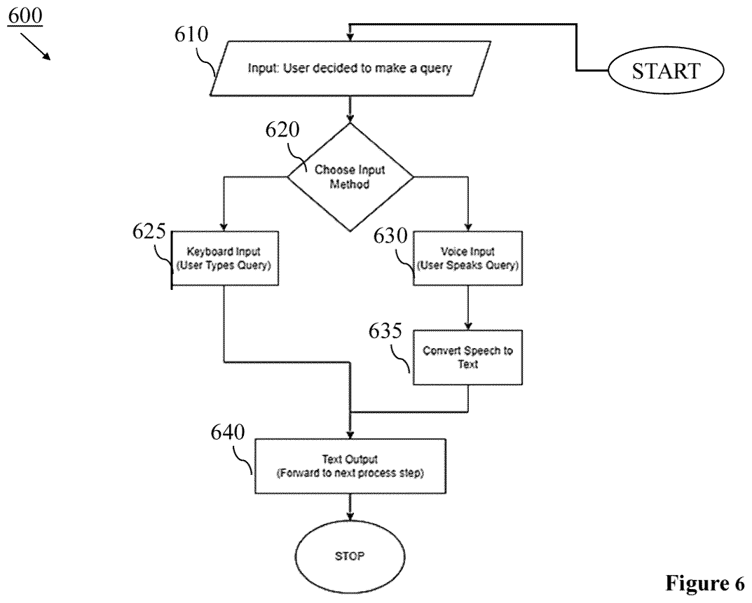

FIG. 6 schematically illustrates a high-level workflow 600 of large language model driven guidance of design and implementation of elements in a user interface, in accordance with some embodiments of the present invention.

According to some embodiments of the present disclosure, when a user decides to make a query 610 as to a UI element in a UI page of an application, a system, such as computerized-system 100 in FIG. 1, may provide the user to choose between two methods of input 620. Keyboard input 625 where the user may type the query and voice input 630 where the user may speak the query to the microphone of the computer.

According to some embodiments of the present disclosure, when the user chooses the keyboard input 625, the user may type their query directly into the system using a keyboard. The system, such as computerized-system 100 in FIG. 1, may operate a direct processing of the text entered by the user without any need for conversion, as it is already in text-format. The processed text, text output 640 may be forwarded to the next module of the system for further processing. This output may be cleaned and processed such that the user query may be ready for assessment.

According to some embodiments of the present disclosure, when the user chooses the voice input 630 the user may speak the query. If the user opts for voice input, they speak their query into a microphone. The spoken query may be captured and recorded into an audio file which may be converted into text using speech-to-text technology. This conversion involves recognizing spoken words and translating them into written text. Similar to the keyboard input path, the converted text may be forwarded to the next system component. The output is also a cleaned and processed text version of the user's spoken query.

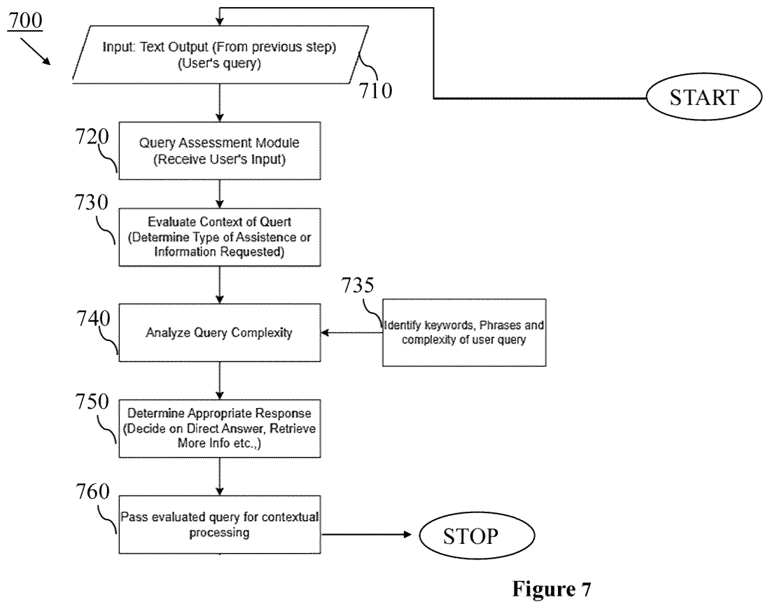

FIG. 7 schematically illustrates a high-level workflow 700 of query assessment module, in accordance with some embodiments of the present invention.

According to some embodiments of the present disclosure, the text output 640 in FIG. 6 may be input 710 to the query assessment module, such as assessment module 330 in FIG. 3, which is the text of the user's query obtained either through keyboard or voice input.

According to some embodiments of the present disclosure, the query assessment module may receive the user's query and prepare it for detailed evaluations 720.

According to some embodiments of the present disclosure, the query assessment module may evaluate the context of the query 730 and determine the type of assistance or information requested. The query assessment module may analyze the query to determine what type of information or assistance the user is seeking, for example, if the query is about a technical issue, a user manual request, or other support needs.

According to some embodiments of the present disclosure, the query assessment module may analyze query complexity 740 by operating a deeper analysis to identify keywords, phrases, and the overall complexity of the query. This analysis may contribute to the understanding of the exact nature of the user's problem or request in the query.

According to some embodiments of the present disclosure, the query assessment module may determine appropriate response 750 which may be the best path for responding to the user. For example, providing a direct answer from a knowledge base, retrieving additional contextual information, or escalating the query to a human operator for more complicated issues.

According to some embodiments of the present disclosure, the query assessment module may send the evaluated query for contextual processing 760, which is the evaluated context of the query to the context retrieval module. The evaluated context of the query may include insights about what information is needed.

According to some embodiments of the present disclosure, the context retrieval module may retrieve contextual guidance and a position of each UI element in the UI elements based on the evaluated context of the query. The context retrieval module may fetch relevant data that matches the user's current state in the application 130 and ensure that the response is targeted.

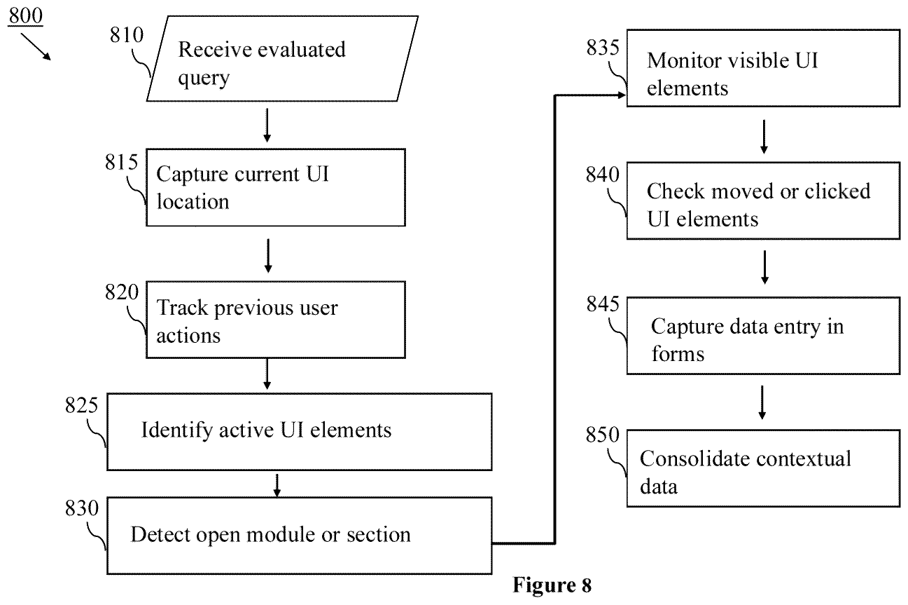

FIG. 8 schematically illustrates a high-level workflow 800 of contextual information retrieval, in accordance with some embodiments of the present invention.

According to some embodiments of the present disclosure, in a system, such as computerized-system 100, a module, such as context retrieval module, may by operated to retrieve contextual guidance and a position of each UI element in the UI page. The context retrieval module may receive the evaluated query 810 from the assessment module.

According to some embodiments of the present disclosure, the context retrieval module may capture current UI location 815 and identify the location of the user within the application's UI page. The context retrieval module may determine which module of the application is in an open state by tracking a Uniform Resource Locator (URL) of modules activated by the application and add the determined module that is in open state to the contextual-data database. The current UI location may contribute to determine the relevance of the query to the current UI context.

According to some embodiments of the present disclosure, the context retrieval module may track previous user actions 820 by analyzing recorded actions of the user during a preconfigured period of time to yield data related to the UI page to be added to the contextual-data database. The context retrieval module may record the actions taken by the user before making the query, to provide insight into the user's workflow and potential issues they might be facing when working on the application 130 in FIG. 1, via the UI 160 in FIG. 1.

According to some embodiments of the present disclosure, the context retrieval module may identify active UI elements 825 in the UI page, which are in an active state, by operating event listeners. The identified UI elements may be added to the contextual-data database. To identify the active UI elements, the contextual retrieval module may examine the UI elements that the user is currently interacting with, such as buttons or text fields which may be directly related to the user's query.

According to some embodiments of the present disclosure, the context retrieval module may detect open module or section 830, in the application, by tracking a Uniform Resource Locator (URL) of modules activated by the application and adding the determined module that is in open state to the contextual-data database, thus providing contextual background to the query. For example, account settings or the dashboard.

According to some embodiments of the present disclosure, the context retrieval module may monitor visible UI elements 835 by checking which UI elements are visible or active on the UI page, that is presented on the display unit, to be added to the contextual-data database. For example, menus, text fields, and other interactive components.

According to some embodiments of the present disclosure, the context retrieval module may check moved or clicked UI elements by checking which UI elements, the user has been hovering on or mouse-clicking during the preconfigured period of time to be added to the contextual-data database. The moved or clicked UI elements during the preconfigured period of time may indicate the focus area of the user's issue or interest.

According to some embodiments of the present disclosure, the context retrieval module may capture data entry in forms 845 by capturing data entered by the user into forms and text fields of the UI page during the preconfigured period of time to be added to the contextual-data database.

According to some embodiments of the present disclosure, the context retrieval module may consolidate contextual data 850 by combining all the collected data in the contextual-data database to refine and tailor the response to the user's needs.

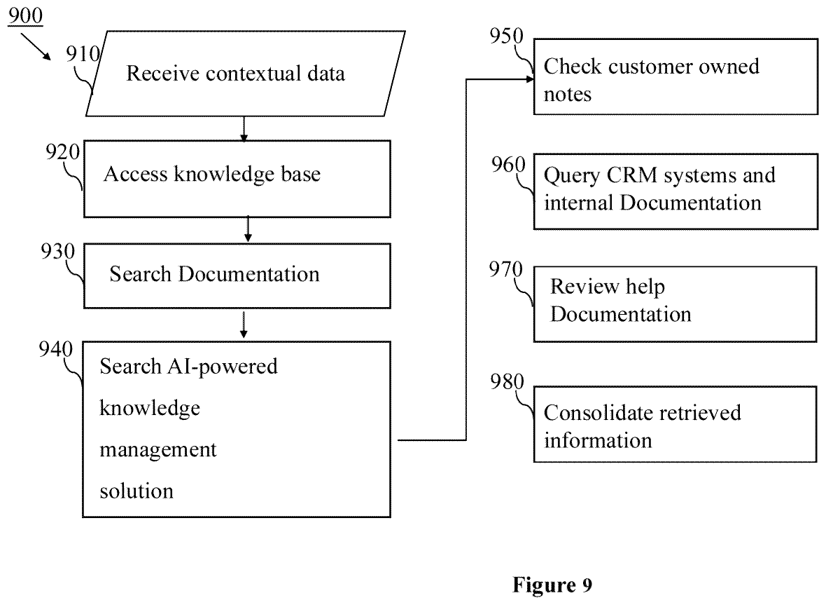

FIG. 9 schematically illustrates a high-level workflow 900 of query knowledge base retrieval, in accordance with some embodiments of the present invention.

According to some embodiments of the present disclosure, the query knowledge base retrieval may begin by receiving the contextual data 910 which has been collected by the context retrieval module and stored in the contextual-data database.

According to some embodiments of the present disclosure, access knowledge base 920 using both the user's explicit query and the contextual data provided, to fetch relevant results.

According to some embodiments of the present disclosure, search documentation 930 based on the user's query and the contextual data.

According to some embodiments of the present disclosure, search AI-powered knowledge management solution 940.

According to some embodiments of the present disclosure, check customer owned notes 950 by searching through any custom or personalized documentation that the customer may have added to the application, which can include unique configurations or issues previously addressed.

According to some embodiments of the present disclosure, query CRM systems and internal documentation 960 by searching through CRM data, internal FAQs, and documentation that might contain useful information to resolve the user's query or provide requested information.

According to some embodiments of the present disclosure, review help documentation 970 by looking into general help guides, manuals, and documentation that are not necessarily specific to the application or the knowledge management platform but may provide valuable insights or solutions to the user's query.

According to some embodiments of the present disclosure, consolidate retrieved information 980 after gathering all the necessary information from the different sources, synthesizing it into a coherent and comprehensive response tailored to the user's specific needs and context.

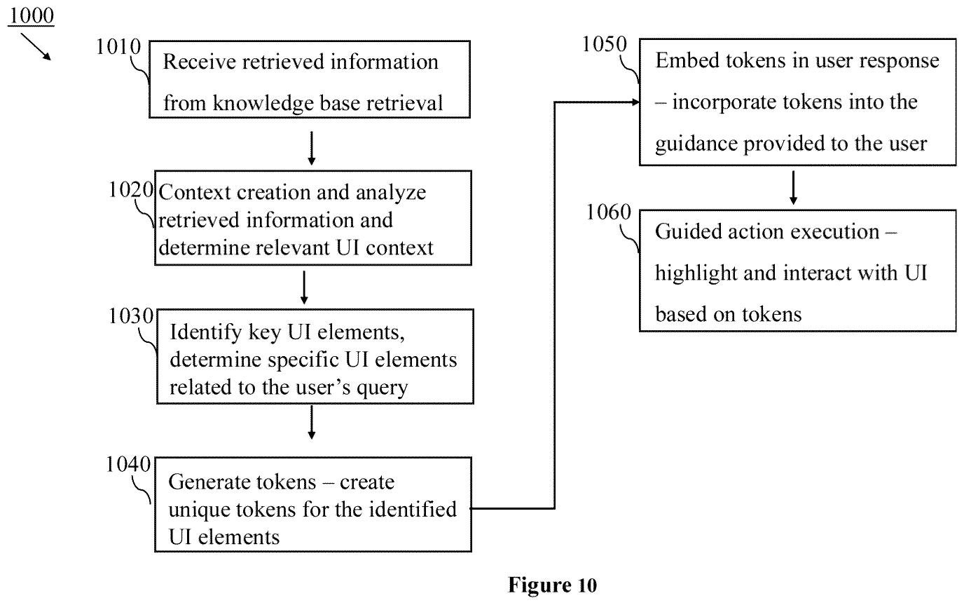

FIG. 10 schematically illustrates a high-level workflow 1000 of context creation and tokenization, in accordance with some embodiments of the present invention.

According to some embodiments of the present disclosure, a system, such as computerized-system 100 in FIG. 1 may receive the retrieved information form the knowledge base retrieval 1010.

According to some embodiments of the present disclosure, the computerized-system 100 in FIG. 1 may operate context creation and analyze retrieved information and determine relevant UI context 1020 where the user is currently active. For example, if the user's query is about resetting a password, the system recognizes that the user is on the account settings page.

According to some embodiments of the present disclosure, the computerized-system 100 in FIG. 1 may identify key UI elements, determined specific UI elements related to the user's query 1030 For example, when the query is about password reset, the “Reset Password” button may be identified and confirmation dialog box as the key elements.

According to some embodiments of the present disclosure, the computerized-system 100 in FIG. 1 may generate tokens and create unique tokens for the identified UI elements. Tokens may be generated for these identified UI elements 1040. For example, tokens like [BTN_RESET_PASSWORD] for the “Reset Password” button and [CONFIRM_DIALOG] for the confirmation dialog box may be created.

According to some embodiments of the present disclosure, the computerized-system 100 in FIG. 1 may embed tokens in user response and incorporate tokens into the guidance provided to the user 1050. This ensures that the response is not only informative but also interactive, directing the user explicitly to the UI elements involved.

According to some embodiments of the present disclosure, the computerized-system 100 in FIG. 1 may operate guided action execution and highlight and interact with UI based on tokens 1060. For example, when the user clicks the tokenized “Reset Password” button, the computerized-system 100 in FIG. 1 may automatically highlight this button and bring up the confirmation dialog box.

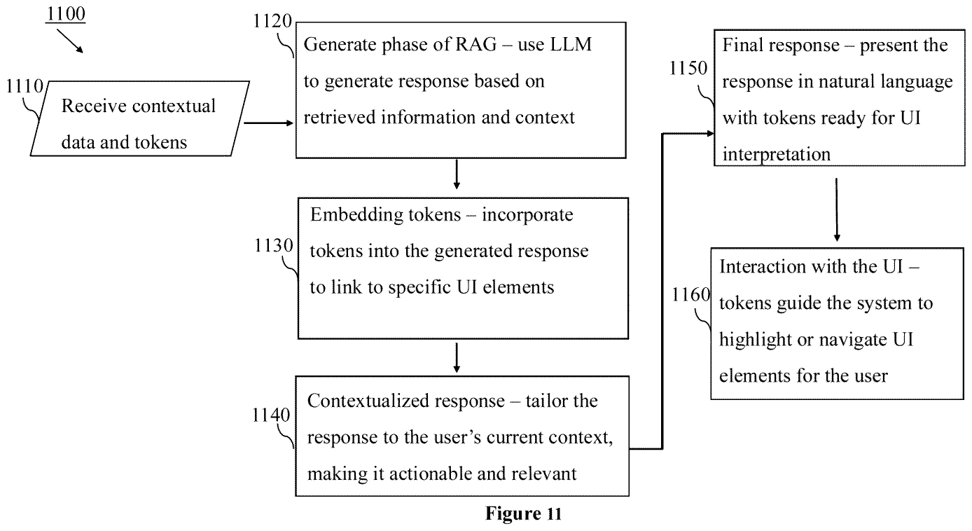

FIG. 11 schematically illustrates a high-level workflow 1100 of prompt generation with context, in accordance with some embodiments of the present invention.

According to some embodiments of the present disclosure, the computerized-system 100 in FIG. 1 may receive contextual data and tokens 1110.

According to some embodiments of the present disclosure, the computerized-system 100 in FIG. 1 may operate a generate phase of RAG by using the LLM to generate response based on retrieved information and context 1120.

According to some embodiments of the present disclosure, the computerized-system 100 in FIG. 1 may embed tokens and incorporate tokens into the generated response to link to specific UI elements 1130. Linking the textual response to interactive UI elements within the UI page, to enhance user guidance.

According to some embodiments of the present disclosure, the computerized-system 100 in FIG. 1 may provide a contextualized response and tailor the response to the user's current context, making it actionable and relevant 1140.

According to some embodiments of the present disclosure, the computerized-system 100 in FIG. 1 may provide the final response and present the response in natural language with tokens ready for UI interpretation 1150, which means the tokens are prepared to function as direct links or guides to the UI elements they represent.

According to some embodiments of the present disclosure, the computerized-system 100 in FIG. 1 may provide the interaction with the UI having the tokens guide the system to highlight or navigate UI elements for the user 1160. With the highlighted UI elements, the user can easily follow the guidance by interacting directly with the UI elements that are referenced in the response.

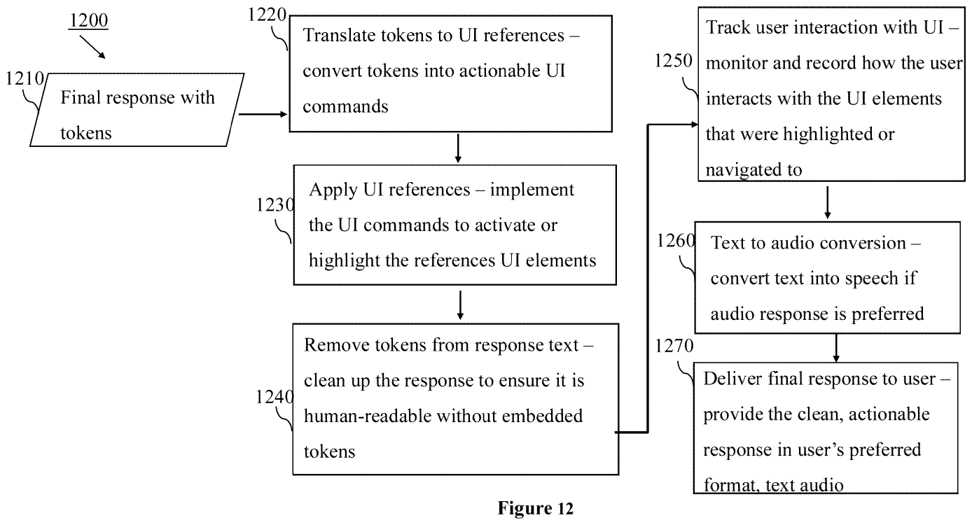

FIG. 12 schematically illustrates a high-level workflow 1200 of token from text removal, text to audio conversion and final response to user, in accordance with some embodiments of the present invention.

According to some embodiments of the present disclosure, final response with tokens 1210 may be received from the LLM.

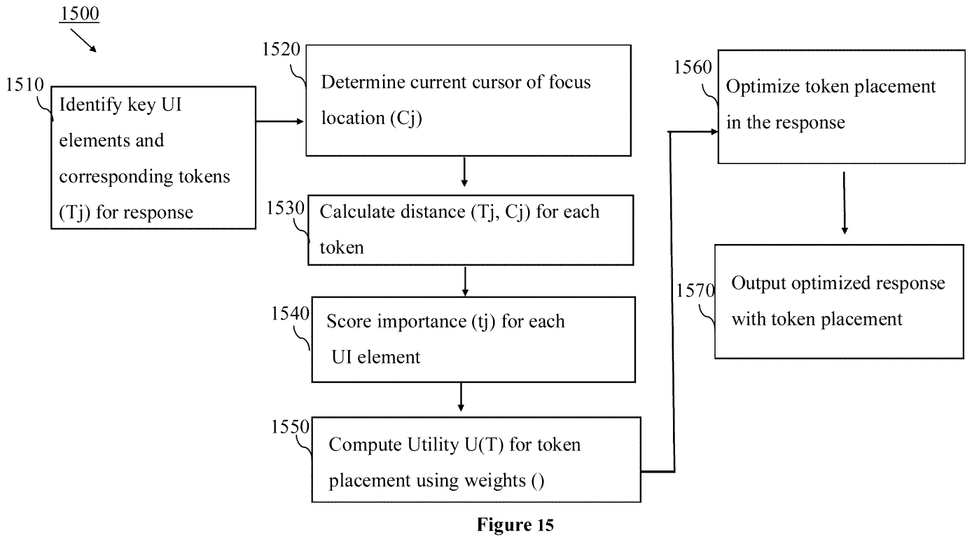

According to some embodiments of the present disclosure, the tokens may be translated to UI references by converting the tokens into actionable UI commands 1220 for example, as shown in FIG. 15. For example, highlighting a button or navigating to a specific interface section. The guidance, e.g. response to the user's query may be displayed as lingual-instructions of the operation of the application in text-format on the UI page and signaling the one or more UI elements related to the query with a visual cue on the UI page based on the position of each UI element in the UI elements.

According to some embodiments of the present disclosure, UI references may be applied by implementing the UI commands to activate or highlight the references UI elements 1230. The translated UI commands may be applied within the application UI, enabling direct interaction based on the user's query.

According to some embodiments of the present disclosure, the tokens may be removed from the response text by cleaning up the response to ensure it is human-readable without embedded tokens 1240.

According to some embodiments of the present disclosure, user interaction with UI may be tracked by monitoring and recording how the user interacts with the UI elements that were highlighted or navigated to 1250. User's interactions with the UI elements have been modified based on the tokens may be monitored and logged for analytics and further system refinements.

According to some embodiments of the present disclosure, optionally, text to audio conversion may be operated where text of the response may be converted into speech if audio response is preferred 1260 for user preference compliance. This preference may be indicated via the UI or may be preconfigured.

According to some embodiments of the present disclosure, final response may be delivered to the user by providing a clean actionable response in user's preferred format 1270, e.g. text or audio. The response to the query may include clear guidance on what actions the user should take within the application via the UI elements in the UI page, based on their query.

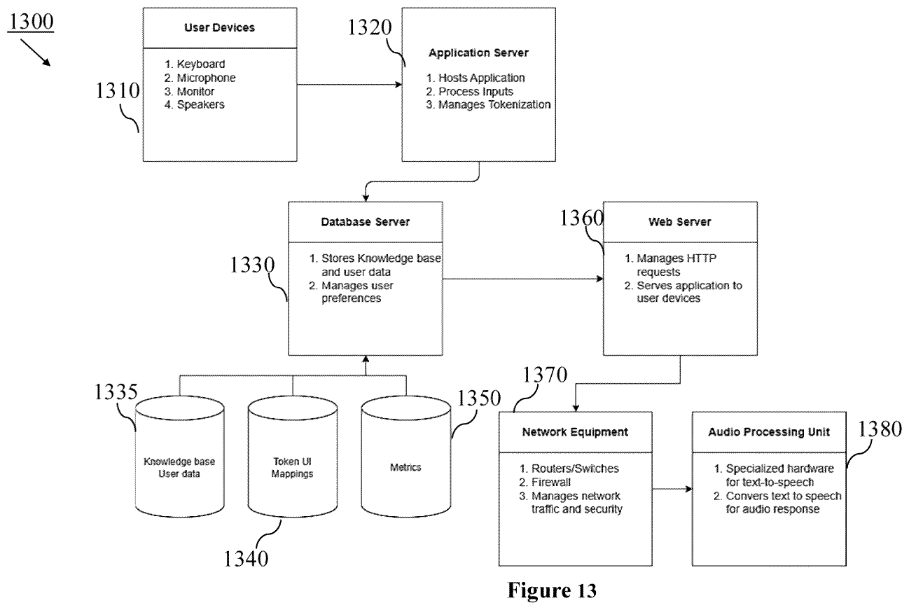

FIG. 13 schematically illustrates a hardware diagram 1300 of large language model driven guidance of design and implementation of elements in a user interface, in accordance with some embodiments of the present invention.

According to some embodiments of the present disclosure, in computerized-system 100 in FIG. 1, the computerized device 140 in FIG. 1, e.g., user devices 1310 may include input components, e.g., a keyboard and microphone which may allow users to input their queries. The user devices may include output components, such as a monitor, and speakers provide visual and audio responses to users.

According to some embodiments of the present disclosure, the application server 1320 may host and run the core application software, e.g., application 130 in FIG. 1, may handle user inputs and process tokenization and generate responses.

According to some embodiments of the present disclosure, the database server 1330 may store all the necessary data, including the knowledge base user data 1335 for the application and user-specific data, such as preferences for response format. Token UI mappings 1340 and metrics 1350, which is the contextual-data database, for example, as shown by element 350 in FIG. 3.

According to some embodiments of the present disclosure, the web server 1360 may manage Hypertext Transfer Protocol (HTTP) requests and is responsible for delivering the application interface to user devices across the network. The web server 1360 may also serve application to user devices 1310.

According to some embodiments of the present disclosure, the network equipment may include routers and switches that facilitate internal network traffic among servers and user devices, and a firewall that ensures network security. The network equipment 1370 may manage network traffic and security.

According to some embodiments of the present disclosure, the audio processing unit 1380 may be a hardware component used for converting text responses into audio format, ensuring high-quality voice output when required.

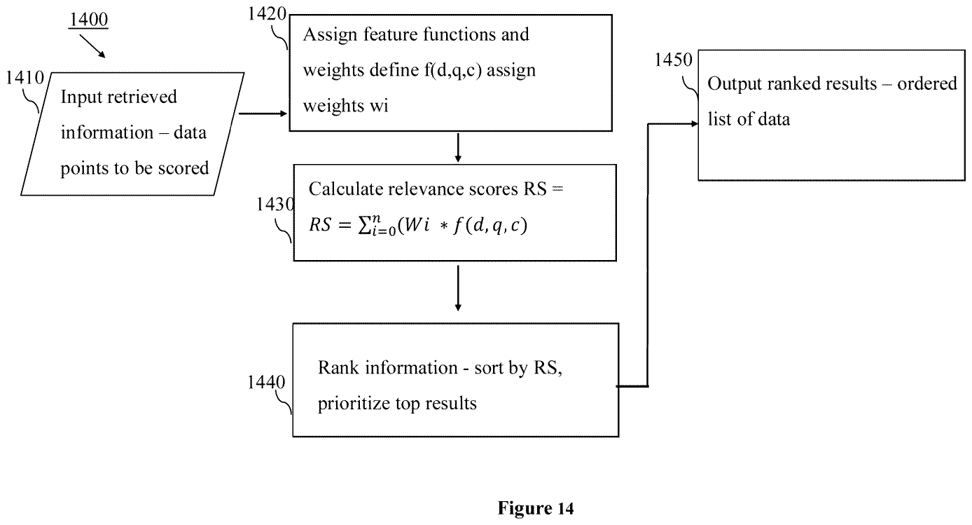

FIG. 14 schematically illustrates a high-level workflow 1400 of context scoring and relevance ranking, in accordance with some embodiments of the present invention.

According to some embodiments of the present disclosure, context scoring and relevance ranking may involve evaluating the importance of various pieces of retrieved information based on the user's current query and contextual data. This process may assign scores to different data points and prioritize the most relevant content that aligns with the user's immediate needs and past behaviors. This information may be ranked, by computerized-system 100 in FIG. 1, to ensure that the most pertinent guidance is provided first.

According to some embodiments of the present disclosure, input retrieved information
data points to be scored 1410.

According to some embodiments of the present disclosure, assign feature functions and weights, define f(d,q,c) and assign wights wᵢ 1420.

According to some embodiments of the present disclosure, calculating relevance scores 1430.

According to some embodiments of the present disclosure, the relevance score may be calculated by formula I:

$$Relevance Score ( RS ) = {\sum }_{i = 1}^{n} ( {w}_{i} ) fi ( d , q , c ) \qquad ( I )$$

### Whereby:

fᵢ(d,q,c) is a feature function that measures the relevance of a document d with respect to a query q and context c,
wᵢ are the weights assigned to each feature function, which can be learned or adjusted based on user feedback and interaction data, and
n is the number of feature functions used, e.g., keyword match, semantic similarity, user history.

According to some embodiments of the present disclosure, for example, if a user frequently interacts with certain features, those features could be weighted more heavily in relevance scoring when similar queries are made in the future.

According to some embodiments of the present disclosure, rank information-sort by relevance score and prioritize top results 1440.

According to some embodiments of the present disclosure, output ranked results in an ordered list of data 1450.

FIG. 15 schematically illustrates a high-level workflow 1500 of token placement optimization, in accordance with some embodiments of the present invention.

According to some embodiments of the present disclosure, token placement optimization focuses on strategically positioning tokens within the generated response to enhance user interaction. This involves determining the most effective locations for tokens that correspond to key UI elements, considering factors like proximity to the user's current focus and the importance of the action. The goal of the token placement optimization is to streamline the user's workflow by minimizing the distance and steps required to complete a task.

According to some embodiments of the present disclosure, user workflow to complete a task U(T) may be calculated according to formula II:

$$U ( T ) = {\sum }_{i = 1}^{m} ( {α}_{j} \times \frac{1}{Distance ( Tj , Cj )} + {β}_{j} \times Importance ( Tj ) ) \qquad ( II )$$

whereby:
Tj represents the token for the jth UI element,
Cj is the current cursor or focus location in the UI,
Distance (Tj,Cj) is a function measuring how far the UI element is from the user's current focus, Importance (Tj) is a score representing the importance of the UI element in completing the task, and αj and βj are weights balancing the proximity and importance.

According to some embodiments of the present disclosure, for example, tokens might be placed closer to UI elements that are both important and near the user's current focus, enhancing usability.

According to some embodiments of the present disclosure, identify key UI elements and corresponding tokens (Ti) for response 1510 to the user's query may be operated by the computerized-system 100 in FIG. 1, which identifies all relevant UI elements that need interaction for the given task and assigns corresponding tokens to each.

According to some embodiments of the present disclosure, determine current cursor or focus location (Cj) 1520 may be operated by detecting where the user's cursor or focus is currently positioned within the UI to measure proximity to identified tokens.

According to some embodiments of the present disclosure, to calculate distance (Tj, Cj) for each token 1530 the physical or navigational distance between each token and the user's current focus may be computed. This might involve pathfinding algorithms or simple geometric calculations depending on the UI page complexity.

According to some embodiments of the present disclosure, the score importance (Tj) for each UI element 1540 may be calculated by assigning an importance score to each UI element based on how critical it is to completing the user's current task. This could be based on frequency of use of the UI element, user preferences, or task criticality. Calculating utility (U (T) for token placement using weights 1550.

According to some embodiments of the present disclosure, the utility U(T) for token placement using weights may be calculated according to formula III:

$$U ( T ) = {\sum }_{i = 1}^{m} ( {α}_{j} \times \frac{1}{Distance ( Tj , Cj )} + {β}_{j} \times Importance ( Tj ) ) \qquad ( III )$$

whereby:
the weights αj and βj may be adjusted to balance proximity and importance based on the application's specific user experience goals.

According to some embodiments of the present disclosure, optimize token placement in the response 1560 by arranging tokens within the generated user response to maximize the overall utility, ensuring that crucial interactions are easier and quicker for the user to access.

According to some embodiments of the present disclosure, output optimized response with token placement 1570 by delivering the optimized response to the user, highlighting or directly interacting with UI elements as designated by the optimal token placements.

According to some embodiments of the present disclosure, for example, having two tokens T₁ and T₂, distance of each token from current focus is: Distance (T₁, C)=2, Distance (T₂, C)=5, the importance score may be calculated for each token, Importance (T₁)=0.8, Importance (T₂)=0.5 and the weights α₁=α₂=0.5, β₁=β₂=0.5

### Calculate Utility U(T):

$$U ( T 1 ) = ( 0.5 \times - 1 + 0.5 \times 0.8 ) = 0.25 + 0.4 = 0.65 \\ U ( T 2 ) = ( 0.5 \times - 1 + 0.5 \times 0.5 ) = 0. 1 + 0.25 = 0.35$$

According to some embodiments of the present disclosure, based on the utility calculations, token T₁ may be positioned more prominently in the response due to its higher utility score, reflecting both its closer proximity and greater importance relative to token T₂. This optimized placement helps streamline the user's interaction, making the system more efficient and user-friendly.

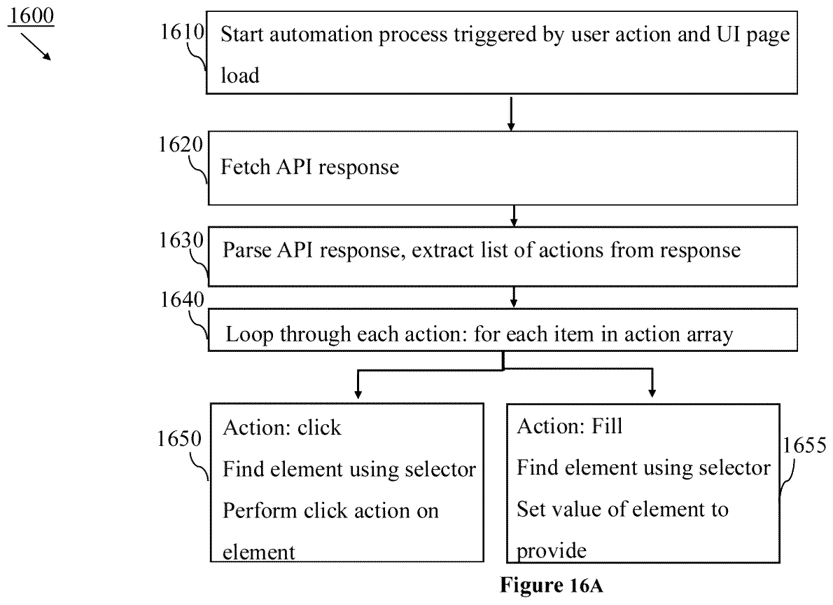

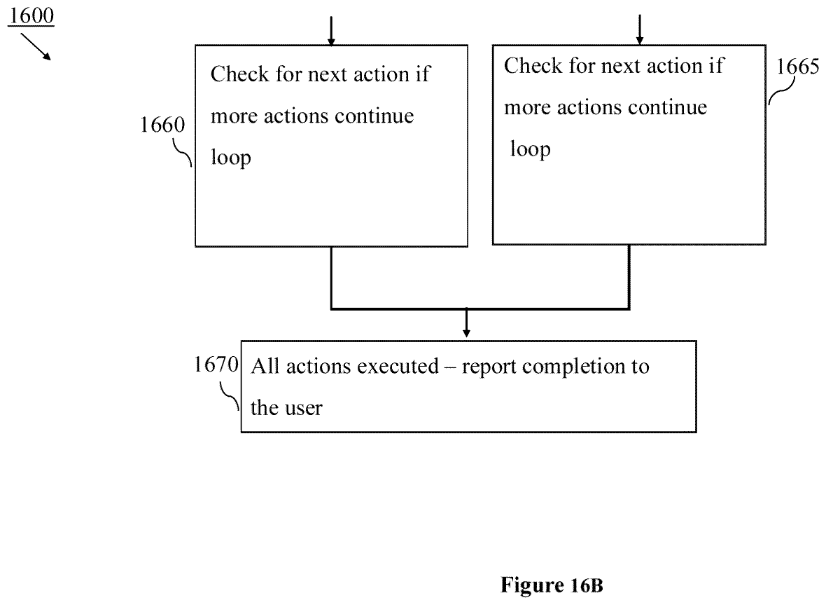

FIGS. 16A-16B schematically illustrates a high-level workflow 1600 of tracking of actions executed by the user, in accordance with some embodiments of the present invention.

According to some embodiments of the present disclosure, computerized-system 100 in FIG. 1 may streamline user interactions within a web-based application by integrating voice commands, automated processing, and dynamic UI manipulation. Initially, user inputs are captured through voice and converted into text using a speech-to-text engine. The text is then processed to discern user intent using natural language processing techniques.

According to some embodiments of the present disclosure, depending on the extracted commands or queries, a response may be formulated, by retrieving data, answering inquiries, or preparing actions for UI adjustments. Optionally, prior to taking any automated actions on the UI page, the system may request user confirmation to ensure accuracy and intent compliance. Once confirmed, the identified actions are translated into DOM manipulations, programmatically executing tasks such as clicking buttons or filling forms as if performed by the user manually.

According to some embodiments of the present disclosure, this automated workflow not only enhances user experience by facilitating quick and natural interactions but also increases efficiency by reducing the manual effort needed to navigate and interact with the application, providing a seamless, responsive service that aligns with modern user expectations of smart, interactive systems.

According to some embodiments of the present disclosure, start automation process triggered by user action and UI page load 1610. The user may provide input through voice, expressing a desire to perform a specific action or query. A speech-to text may be operated when the input is voice input. The voice input may be captured and converted into text using a speech-to-text engine, which could be part of a broader Natural Language Processing (NLP) service.

According to some embodiments of the present disclosure, the converted text may be processed to understand the user's intent. The processing of the text may involve NLP techniques to parse the text and extract actionable commands or queries.

According to some embodiments of the present disclosure, fetch API response from 1620, based on the processed text, computerized-system 100 in FIG. 1 may determine the response, and the set of actions required to fulfill the user's request. This could involve querying a database, fetching data from a server, or preparing commands for UI manipulation.

According to some embodiments of the present disclosure, parse LLM response, extract list of actions from response 1630, computerized-system 100 in FIG. 1 may compile the response which could be informational, e.g., answering a query or actionable steps to be taken. This response is formatted suitably for the user to review.

According to some embodiments of the present disclosure, depending on the system design and the nature of the action, the user may be asked to confirm before operating the automated actions execution. This step ensures that the system has correctly understood the command and that the user consents to proceed.

According to some embodiments of the present disclosure, the response may be converted to Document Object Model (DOM) actions. If the user confirms or if confirmation isn't needed, the response may be parsed by a DOM manipulation module. This module interprets the response into specific DOM actions, like clicking a button, filling out a form, navigating to a different part of the application, etc.

According to some embodiments of the present disclosure, the automated actions may be executed by the computerized-system 100 in FIG. 1. The parsed DOM actions are executed on the webpage. This involves programmatically manipulating the web interface to perform tasks as if they were being done manually by the user. For example, loop through each action: for each item in the action array 1640, action: click, find element using selector perform click action on element 1650, action: fill, find element using selector, set value of element to provide the required input value from the API response, user input, or predefined data and fills it into the corresponding UI element 1655, after each action, check for next action if more actions continue loop 1660, 1665.

According to some embodiments of the present disclosure, after all actions have been executed reporting completion to the user 1670. After executing the actions, the system provides feedback to the user, confirming the completion of the tasks, or reporting any issues encountered during the process.

According to some embodiments of the present disclosure, for example, in a web-based customer service portal, when a user wants to check the status of a service ticket. The user may query by the following voice command: “Check the status of my latest service ticket.”.

According to some embodiments of the present disclosure, the computerized-system 100 in FIG. 1 may operate as follows. The speech may be converted to text. The text may be processed to understand the command. Then, the system may check the latest ticket status from the database. A response may be compiled and read back to the user: “Your latest ticket is still in progress. Would you like to perform any actions on this ticket?” Upon user confirmation, further actions could be triggered, such as updating the ticket status or sending a follow-up query.

FIGS. 17A-17I are examples of User Interfaces (UI) s for large language model driven guidance of design and implementation of elements in a user interface, in accordance with some embodiments of the present invention.

According to some embodiments of the present disclosure, when a user is working on an application, such as application 130 in FIG. 1, via a UI, such as UI 160 in FIG. 1, for example UI 1700A in FIG. 17A, may request assistance via a button, such as button 1710a.

According to some embodiments of the present disclosure, in FIG. 17A there is a lot of graphical content that a user may have trouble understanding how to use. There are menu icons to the left, table data with abstract icons at the bottom, and action toolbar towards the top. There are also graphical widgets in the middles and other interactive elements in the top right. Should a user have a question about navigating or interacting with the user interface, they can put their mouse over the “?” icon 1710a representing different sources of help.

According to some embodiments of the present disclosure, Once a user's mouse pointer hovers over the “?” icon, a drop-down menu appears with various options. These could be links to general documentation (“help”) or details about the application (“about”). The third option may be “Ask the AI”. Clicking on button 1710a may open a dropdown window 1710b in FIG. 17B with “ask the AI” option 1710c in FIG. 17C.

According to some embodiments of the present disclosure, a click on the “ask the AI” option 1710c in FIG. C, may trigger the operation of a system, such as computerized-system 100 in FIG. 1, which is a process that interacts with an LLM for resolving the user's query. Optionally, the query may be entered via voice input, as shown in FIGS. 17D-17I. The user's query may be entered via keyboard.

According to some embodiments of the present disclosure, a web-based display dialog may be shown with a recording button, for example, as shown in FIG. 17D. This button is a visual indication that the expect user interaction is to record a verbal question. The user may move the mouse pointer to the microphone icon and press down on the mouse button and hold.

According to some embodiments of the present disclosure, this may activate front-end web scripts that turn on the workstation's microphone and begin capturing incoming audio. The icon may turn red to indicate recording microphone is now on. The end user can verbally ask their question. The recording only stops when the end user releases the mouse button.

According to some embodiments of the present disclosure, upon releasing the mouse button, the captured audio may be serialized and sent over medium to the backend application in the network. During this time, the backend may convert the audio into text and enrich with contexts before sending through RAG and LLM for constructing an answer to the user's query.

According to some embodiments of the present disclosure, the microphone popup may show a loading indication to inform the users that getting the answer to their question is in progress. For example, as shown in FIG. 17F. This may only change once a response arrives or there is a failure. When an LLM returns with UI reference context, the application, such as application 130 in FIG. 1, may map that to the UI element that is present in the user's screen and covert the text answer into a verbal audio. These are returned to the end user's local screen as the response.

According to some embodiments of the present disclosure, the user's query may be for example, “how do I view the notes of a work item?”. The computerized-system 100 in FIG. 1 may capture the query and tokenize it for processing. For example, by operating the assessment module, preparing the query for an evaluation, determining a type of guidance by analyzing the prepared query, identifying keywords, phrases and complexity of the query, by operating pretrained machine learning models, determining a source of response to the query and priority level based on the identified keywords, phrases and complexity of the query.

According to some embodiments of the present disclosure, the source of response, the type of guidance, and the priority level may be forwarded as the evaluated context of the query to the contextual retrieval module based. The contextual retrieval module may retrieve contextual guidance and a position of relevant UI elements based on the evaluated context of the query in the UI page based on the evaluated context of the query. The contextual guidance and the position of each UI element may be stored in a contextual-data database.

According to some embodiments of the present disclosure, contextual retrieval module may receive the evaluated context of the query and add the following to the contextual-data database. identified position of the UI element, data related to the UI page based on an analysis of recorded actions of the user during a preconfigured period of time, identified UI elements in the UI page which are in an active state, module of the application that is in an open state, UI elements which are visible or active on the UI page that is presented on the display unit, UI elements that the user has been one hovering on or mouse-clicking during the preconfigured period of time, data entered by the user into forms and text fields of the UI page during the preconfigured period of time.

According to some embodiments of the present disclosure, for example, the retrieved guidance information by the context retrieval module may be as follows
UI page: “Customer Interaction”
Role of user: Level 1 Support Agent
Recent Actions: Accessed customer billing details
Identified Position of the UI Element: “Billing Details Section—(X:150, Y:300)”
Data Related to the UI Page Based on User's Recorded Actions: “User navigated from ‘Customer Profile’ to ‘Billing Details’ and then viewed ‘Payment History’”
Identified UI Elements in the UI Page Which Are in an Active State: “Billing Inquiry Form-Active, Submit Button-Enabled”
Module of the Application That is in an Open State: “Customer Management Module”
UI Elements Which Are Visible or Active on the UI Page: “Customer Name Field, Account Balance Display, Billing Inquiry Form, Payment Status Section”
UI Elements That the User Has Been Hovering Over or Mouse-Clicking During the Preconfigured Period of Time: “Mouse hovered over ‘Update Billing Address’ button, Clicked on ‘View Payment History’ link”

Data Entered by the User into Forms and Text Fields of the UI Page: “Entered new email in ‘Contact Email’ field, Updated phone number in ‘Support Contact’ field”

According to some embodiments of the present disclosure, the source of response to the query which has been determent by the assessment module, may be accessed to query based on the guidance information. For example, when the source of response has been determent as the knowledge base, a Retrieval-Augmented Generation (RAG) retrieval may be operated therefrom. The search scope in the knowledge base may be internal documentation, past case studies and FAQs.

According to some embodiments of the present disclosure, for example, relevant guidelines to the user's query, case resolutions, and tools may be retrieved.

According to some embodiments of the present disclosure, the retrieved data from the knowledge base may be retrieved and combined with the context of the UI page. Tokens may be generated to be embedded in the response. The retrieved data from the knowledge base may be combined with the context of the current UI page that the user is interacting with. This ensures that the response generated is not only informed by the knowledge base but also contextually relevant to the user's current workflow within the application 130.

According to some embodiments of the present disclosure, when a response returns from computerized-system 100 in FIG. 1, to the application, several operations may be performed simultaneously. The microphone popup presented on the UI may disappear A text-based display of the answer in a floating text message may be displayed. For example, as shown in FIG. 17G. This is for cases of a user's reading preference or impairment in hearing.

According to some embodiments of the present disclosure, providing the retrieved data combined with the current UI state and the embedded tokens to the LLM to receive a response, such as “To view the notes of a Work item, first select a work item from the grid and then click on the ‘view notes’ icon.” For example, as shown in UI 1700G in FIG. 17G.

According to some embodiments of the present disclosure, optionally, computerized-system 100 in FIG. 1 may direct the user's focus to the relevant UI elements and provide a context-aware guidance for the user's query by highlighting UI elements that relate to the query. For example, ‘view notes’ icon, as shown in FIG. 17H.

According to some embodiments of the present disclosure, the UI element related to the answer, e.g., “view notes” button may be highlighted with a border, as a visual indication of the subject element in question, which is signaling the UI elements related to the query with the visual cue on the UI page based on the position of the UI elements. A floating bouncing arrow may appear over the UI element, as shown in FIG. 17I the user interface can be very crowded with graphical content that even a highlighting could be missed, therefore a more visual attention gripping component is employed.

According to some embodiments of the present disclosure, using standard web libraries an audio voice response may be played corresponding to the answer text.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure. While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for large language model driven guidance of design and implementation of elements in a user interface, said computerized-method comprising:
(i) receiving, by one or more processors, from a user, a query related to a User Interface (UI) page of an application, that is running on a computerized-device, and presented on a display unit associated to the computerized-device,
wherein the query is related to an operation of the application, by one or more elements of the UI;
(ii) processing the received query, by the one or more processors, to yield position of each element in the one or more UI elements related to the query on the UI page and a guidance in text-format of the one or more UI elements; and
(iii) displaying the guidance as lingual-instructions of the operation of the application in text-format on the UI page and signaling the one or more UI elements related to the query with a visual cue on the UI page based on the position of each UI element in the one or more UI elements.

2. The computerized-method of claim 1, wherein the processing of the query comprising:
(i) evaluating context of the query by transferring the query, by the one or more processors to an assessment module and operating the assessment module, by the one or more processors;
(ii) retrieving contextual guidance and a position of each UI element in the one or more UI elements by operating a context retrieval module based on the evaluated context of the query;
(iii) using the retrieved contextual guidance to search in one or more sources of information and retrieve guidance-information;
(iv) determining UI context based on an analysis of the guidance-information, wherein the UI context comprising currently viewed UI page, actions operated via the UI page, related user-input, active UI elements and details of the user;
(v) identifying one or more UI elements related to the query based on the UI context and generating a token for each UI element in the one or more UI elements, with metrics of the UI element,
wherein said metrics include an assigned name of the UI element and the position of the UI element on the UI page, and
(vi) embedding the assigned name of each UI element in the guidance in text-format.

3. The computerized-method of claim 1, wherein the query is received by one of: keyboard input and voice input,
wherein when the query is received by the voice input, the computerized-method is further comprising converting the voice input into text by using a speech-to-text tool.

4. The computerized-method of claim 1, wherein the computerized-method further comprising playing voice-instructions of the operation in the application in audio-format, wherein the voice-instructions are corresponding to the lingual-instructions of the operation in the application in text-format.

5. The computerized-method of claim 1, wherein the computerized-method further comprising:
(i) monitoring, by the one or more processors, to calculate number of queries related to each operation of each UI element in each UI page of the application during a preconfigured time;
(ii) generating a report with a preconfigured number of UI elements having highest number of queries; and
(iii) displaying the report via a display unit.

6. The computerized-method of claim 2, wherein said assessment module comprising:
(i) receiving the query;
(ii) preparing the query for an evaluation;
(iii) determining a type of guidance by analyzing the prepared query;
(iv) identifying keywords, phrases and complexity of the query, by operating pretrained machine learning models,
wherein said complexity of the query comprising one or more factors;
(v) determining a source of response to the query and priority level based on the identified keywords, phrases and complexity of the query; and
(vi) sending the source of response, the type of guidance, and the priority level as the evaluated context of the query to the context retrieval module.

7. The computerized-method of claim 6, wherein the LLM is further trained by:
(i) mapping predefined IDs of elements of the UI to text labels by using a UI tool;
(ii) analyzing a hierarchy of the elements of the UI and respective position in the UI page, leveraging the predefined ID for each element in the elements of the UI, by using said UI tool;
(iii) providing a mapping document that links keywords and phrases to elements of the UI page; and
(iv) providing a product documentation of the application to be ingested by the LLM based on descriptive information of the elements of each UI page.

8. The computerized-method of claim 6, wherein said type of guidance is one of: (i) technical issue; (ii) user manual request; (iii) troubleshooting assistance; (iv) configuration support;
(v) error message clarification; (vi) warning message clarifications; and (vii) feature explanation.

9. The computerized-method of claim 2, wherein said context retrieval module comprising:
(i) receiving the evaluated context of the query;
(ii) identifying a position of the UI element to be added to a contextual-data database;
(iii) analyzing recorded actions of the user during a preconfigured period of time to yield data related to the UI page to be added to the contextual-data database;
(iv) identifying UI elements in the UI page which are in an active state by operating event listeners,
wherein the identified UI elements are added to the contextual-data database;
(v) determining which module of the application is in an open state by tracking a Uniform Resource Locator (URL) of modules activated by the application and adding the determined module that is in open state to the contextual-data database;
(vi) checking which UI elements are visible or active on the UI page that is presented on the display unit to be added to the contextual-data database;
(vii) checking which UI elements, the user has been one of: hovering on and mouse-clicking during the preconfigured period of time to be added to the contextual-data database; and
(viii) capturing data entered by the user into forms and text fields of the UI page during the preconfigured period of time to be added to the contextual-data database.

10. The computerized-method of claim 1, wherein the one or more sources of information are at least one of: (i) knowledge base; (ii) documentation; (iii) knowledge management platform;
(iv) custom documentation notes; (v) Customer Relationship Management (CRM) systems.

11. One or more non-transitory, computer-readable media, storing instructions thereon that cause one or more processors to perform operations comprising:
(i) receiving, by one or more processors from a user via a computerized-device, a query related to a User Interface (UI) page of an application, that is running on the computerized-device, and presented on a display unit associated to the computerized-device,
wherein the query is related to an operation of the application, by one or more elements of the UI;
(ii) processing the received query by the one or more processors to yield position of the one or more UI elements related to the query on the UI page and a guidance in text-format of the one or more elements; and
(iii) displaying the guidance as lingual-instructions of the operation of the application in text-format on the UI page and signaling the one or more UI elements related to the query with a visual cue on the UI page based on the position of each UI element in the one or more UI elements.

12. A computerized-system for large language model driven guidance of design and implementation of elements in a user interface, said computerized-system comprising:
one or more processors in communication with at least one non-transitory computer readable medium having software instructions stored thereon, wherein the one or more processors, upon execution of the software instructions, are configured to:
(i) receive, by the one or more processors from a user via a computerized-device, a query related to a User Interface (UI) page of an application, that is running on the computerized-device, and presented on a display unit associated to the computerized-device,
wherein the query is related to an operation of the application, by one or more elements of the UI;
(ii) process the received query by the one or more processors to yield position of the one or more UI elements related to the query on the UI page and a guidance in text-format of the one or more elements; and
(iii) display the guidance as lingual-instructions of the operation of the application in text-format on the UI page and signaling the one or more UI elements related to the query with a visual cue on the UI page based on the position of each UI element in the one or more UI elements.
